(19) United States
(12) Patent Application Publication
(10) Pub. No.: US 2018/0094221 A1
(43) Pub. Date: Apr. 5, 2018

(54) LAUNDRY DETERGENT COMPOSITION

(71) Applicant: The Procter & Gamble Company, Cincinnati, OH (US)

(72) Inventors: Andre CHIEFFI, Tynemouth (GB); Alan Thomas BROOKER, Newcastle upon Tyne (GB); Craig Adam WILKINSON, Newcastle upon Tyne (GB); Linsey Sarah FULLER, Newcastle upon Tyne (GB); Paul Anthony GOULD, Newcastle upon Tyne (GB); Hossam Hassan TANTAWY, Northumberland (GB); Neil Joseph LANT, Newcastle upon Tyne (GB)

(21) Appl. No.: 15/723,196

(22) Filed: Oct. 3, 2017

(30) Foreign Application Priority Data
Oct. 3, 2016 (EP) 16192026.9

(51) Int. Cl. C11D 17/06; C11D 3/386; C11D 1/24; C11D 3/37; C11D 3/12; C11D 1/75; C11D 3/22; C11D 3/39; C11D 3/30; C11D 3/33; C11D 3/34; C11D 3/26; C11D 3/50; C11D 3/20

(52) U.S. Cl. CPC C11D 17/06; C11D 3/2093; C11D 1/24; C11D 3/3715; C11D 3/122; C11D 3/124; C11D 3/38627; C11D 1/75; C11D 3/3707; C11D 3/225; C11D 3/3723; C11D 3/3942; C11D 3/30; C11D 3/33; C11D 3/349; C11D 3/3418; C11D 3/26; C11D 3/3481; C11D 3/50; C11D 3/38609

(57) ABSTRACT

The present invention relates to a solid free flowing particulate laundry detergent composition including:
(a) anionic detersive surfactant;
(b) wherein the composition is essentially free of zeolite builder;
(c) wherein the composition is essentially free of phosphate builder;
(d) wherein the composition is essentially free of sodium carbonate;
(e) wherein the composition is essentially free of sodium silicate;
(f) from about 4 wt % to about 20 wt % organic acid,
(g) a variant of the wild-type amylase from Bacillus sp. which has at least 90% identity for amino acid sequence SEQ ID NO:5, and which includes one or more mutations at positions N195, G477, G304, W140, W189, D134, V206, Y243, E260, F262, W284, W347, W439, W469 and/or G476,
wherein the composition at 1 wt % dilution in deionized water at 20° C., has an equilibrium pH in the range of from about 6.5 to about 9.0.

### FIELD OF THE INVENTION

The present invention relates to a solid free flowing particulate laundry detergent composition having a low pH profile. The compositions of the present invention provide good solubility profile, good cleaning profile, good stability profile and good fabric care profile.

### BACKGROUND OF THE INVENTION

Laundry detergent powder manufacturers seek to provide solid free-flowing particulate laundry detergent compositions that have good solubility profile, good cleaning profile, good stability profile and good fabric care profile. Typically, a performance balance is required between the chosen formulation to ensure that these profile requirements are met.

The pH profile of a typical laundry detergent powder is quite high, around pH 10.5 and sometimes even higher. This pH profile ensures the good performance of historic cleaning mechanisms: such as grease saponification mechanisms and/or fabric fibre swelling mechanisms. However, this high pH profile also means that the detergent formulators are having to address problems with improving the fabric care profile, and ensuring fabric appearance performance and/or fabric shape retention performance is still adequate.

The inventors have found that an alternative approach to this historic dichotomy of formulating high pH detergent powders to ensure good cleaning performance whilst needing to balance the formulation so as to also provide good fabric care performance, is to formulate the solid detergent powder at a lower pH and then to balance the formulation so as to also provide good cleaning performance.

This low pH laundry detergent powder formulation approach ensures good fabric appearance and good fabric care profiles, but careful attention is needed to ensure good cleaning performance, and especially to address any undesirable cleaning performance skews that result due to the low pH profile.

The inventors have found that the cleaning performance of low pH laundry detergent powders can be improved by careful formulation of specific technologies as defined by the present invention.

In particular, the inventors have found that a good cleaning performance is achieved by the combination of a low pH solid laundry detergent powder when formulated using a specific amylase together with the specific formulation features required by the present invention.

WO00/18856 relates to compositions comprising amylase. However, the compositions disclosed by WO00/18856 differ from the composition required by the present invention. In particular, example composition E of WO00/18856 has a calculated pH of 9.7. This is higher (more alkaline) than the pH profile required by the present invention. Data in the application shows the benefit of combining the reduced pH profile with the specific amylase and other formulation features required by the present invention. Example 5 and example 7 demonstrate the improvement achieved by the present invention (example 5) compared to a detergent having a pH profile of 9.7 (example 7).

WO03/038028 relates to compositions comprising amylase. However, the compositions disclosed by WO03/038028 differ from the compositions required by the present invention. In particular, example E of WO03/18856 comprises high levels of carbonate in excess of the levels required by the present invention. Data in the application shows the benefit of formulating at lower sodium carbonate levels when formulated in combination with the other formulation features required by the present invention. Example 5 and example 6 demonstrate the improvement achieved by the present invention (example 5) compared to a detergent comprising higher levels of sodium carbonate (example 6).

### SUMMARY OF THE INVENTION

The present invention relates to a solid free flowing particulate laundry detergent composition comprising:
(a) anionic detersive surfactant;
(b) from 0 wt % to 8 wt % zeolite builder;
(c) from 0 wt % to 4 wt % phosphate builder;
(d) from 0 wt % to 8 wt % sodium carbonate;
(e) from 0 wt % to 8 wt % sodium silicate;
(f) from 4 wt % to 20 wt % organic acid,
(g) a variant of the wild-type amylase from Bacillus sp. which has at least 90% identity for amino acid sequence SEQ ID NO:5, and which comprises one or more mutations at positions N195, G477, G304, W140, W189, D134, V206, Y243, E260, F262, W284, W347, W439, W469 and/or G476,

wherein the composition at 1 wt % dilution in deionized water at 20° C., has an equilibrium pH in the range of from 6.5 to 9.0.

### DETAILED DESCRIPTION OF THE INVENTION

The solid free flowing particulate laundry detergent composition comprises:
(a) anionic detersive surfactant;
(b) from 0 wt % to 8 wt % zeolite builder;
(c) from 0 wt % to 4 wt % phosphate builder;
(d) from 0 wt % to 8 wt % sodium carbonate;
(e) from 0 wt % to 8 wt % sodium silicate;
(f) from 4 wt % to 20 wt % organic acid,
(g) a variant of the wild-type amylase from Bacillus sp. which has at least 90% identity for amino acid sequence SEQ ID NO:5, and which comprises one or more mutations at positions N195, G477, G304, W140, W189, D134, V206, Y243, E260, F262, W284, W347, W439, W469 and/or G476,

wherein the composition at 1 wt % dilution in deionized water at 20° C., has an equilibrium pH in the range of from 6.5 to 9.0, preferably from 6.5 to 8.0.

Solid Free-Flowing Particulate Laundry Detergent Composition:

Typically, the solid free-flowing particulate laundry detergent composition is a fully formulated laundry detergent composition, not a portion thereof such as a spray-dried, extruded or agglomerate particle that only forms part of the laundry detergent composition. Typically, the solid composition comprises a plurality of chemically different particles, such as spray-dried base detergent particles and/or agglomerated base detergent particles and/or extruded base detergent particles, in combination with one or more, typically two or more, or five or more, or even ten or more particles selected from: surfactant particles, including surfactant agglomerates, surfactant extrudates, surfactant needles, surfactant noodles, surfactant flakes; phosphate particles; zeolite particles; polymer particles such as carboxylate polymer particles, cellulosic polymer particles, starch particles, polyester particles, polyamine particles, terephthalate polymer particles, polyethylene glycol particles; aesthetic particles such as coloured noodles, needles, lamellae particles and ring particles; enzyme particles such as protease granulates, amylase granulates, lipase granulates, cellulase granulates, mannanase granulates, pectate lyase granulates, xyloglucanase granulates, bleaching enzyme granulates and co-granulates of any of these enzymes, preferably these enzyme granulates comprise sodium sulphate; bleach particles, such as percarbonate particles, especially coated percarbonate particles, such as percarbonate coated with carbonate salt, sulphate salt, silicate salt, borosilicate salt, or any combination thereof, perborate particles, bleach activator particles such as tetra acetyl ethylene diamine particles and/or alkyl oxybenzene sulphonate particles, bleach catalyst particles such as transition metal catalyst particles, and/or isoquinolinium bleach catalyst particles, pre-formed peracid particles, especially coated pre-formed peracid particles; filler particles such as sulphate salt particles and chloride particles; clay particles such as montmorillonite particles and particles of clay and silicone; flocculant particles such as polyethylene oxide particles; wax particles such as wax agglomerates; silicone particles, brightener particles; dye transfer inhibition particles; dye fixative particles; perfume particles such as perfume microcapsules and starch encapsulated perfume accord particles, or pro-perfume particles such as Schiff base reaction product particles; hueing dye particles; chelant particles such as chelant agglomerates; and any combination thereof.

Typically, the solid free flowing particulate laundry detergent composition comprises:
(a) anionic detersive surfactant;
(b) from 0 wt % to 8 wt % zeolite builder;
(c) from 0 wt % to 4 wt % phosphate builder;
(d) from 0 wt % to 8 wt % sodium carbonate;
(e) from 0 wt % to 8 wt % sodium silicate; and (f) from 4 wt % to 20 wt % organic acid.

Typically, the composition at 1 wt % dilution in deionized water at 20° C., has an equilibrium pH in the range of from 6.5 to 9.0, preferably from 6.5 to 8.5, more preferably from 7.0 to 8.0.

Typically, the composition at 1 wt % dilution in deionized water at 20° C., has a reserve alkalinity to pH 7.0 of less than 4.0gNaOH/100 g, preferably less than 3.0gNaOH/100 g, or even less than 2.0gNaOH/100 g.

As used herein, the term “reserve alkalinity” is a measure of the buffering capacity of the detergent composition (g/NaOH/100 g detergent composition) determined by titrating a 1% (w/v) solution of detergent composition with hydrochloric acid to pH 7.0 i.e. in order to calculate Reserve Alkalinity as defined herein:

$$Reserve Alkalinity ( to pH 7.0 ) as \% alkali in g NaOH \text{/} 100 g product = \frac{T \times M \times 40 \times Vol}{10 \times Wt \times Aliquot}$$

T=titre (ml) to pH 7.0
Molarity of HCl=0.2
40=Molecular weight of NaOH
Vol=Total volume (ie. 1000 ml)
Weight of product (10 g)
Aliquot=(100 ml)

Obtain a 10 g sample accurately weighed to two decimal places, of fully formulated detergent composition. The sample should be obtained using a Pascall sampler in a dust cabinet. Add the 10 g sample to a plastic beaker and add 200 ml of carbon dioxide-free de-ionised water. Agitate using a magnetic stirrer on a stirring plate at 150 rpm until fully dissolved and for at least 15 minutes. Transfer the contents of the beaker to a 1 litre volumetric flask and make up to 1 litre with deionised water. Mix well and take a 100 mls±1 ml aliquot using a 100 mls pipette immediately. Measure and record the pH and temperature of the sample using a pH meter capable of reading to ±0.01 pH units, with stirring, ensuring temperature is 21° C.+/−2° C. Titrate whilst stirring with 0.2M hydrochloric acid until pH measures exactly 7.0. Note the millilitres of hydrochloric acid used. Take the average titre of three identical repeats. Carry out the calculation described above to calculate the reserve alkalinity to pH 7.0.

Typically, the composition comprises from 30 wt % to 90 wt % base detergent particle, wherein the base detergent particle comprising (by weight of the base detergent particle): (a) from 4 wt % to 35 wt % anionic detersive surfactant; (b) optionally, from 1 wt % to 8 wt % zeolite builder; (c) from 0 wt % to 4 wt % phosphate builder; (d) from 0 wt % to 8 wt %, preferably from 0 wt % to 4 wt %, sodium carbonate; (e) from 0 wt % to 8 wt %, preferably from 0 wt % to 4 wt %, sodium silicate; (f) from 1 wt % to 10 wt % organic acid; and (g) optionally, from 1 wt % to 10 wt % magnesium sulphate. Typically, the base detergent particle is in the form of a spray-dried particle.

Typically, the organic acid comprises citric acid and the base detergent particle comprises from 1 wt % to 10 wt % citric acid.

The organic acid may be at least partially coated, or even completely coated, by a water-dispersible material. Water-dispersible material also typically includes water-soluble material. A suitable water-dispersible material is wax. A suitable water-soluble material is citrate.

Typically, the anionic detersive surfactant comprises alkyl benzene sulphonate and wherein the base detergent particle comprises from 4 wt % to 35 wt % alkyl benzene sulphonate.

Typically, the base detergent particle comprises from 0.5 wt % to 5 wt % carboxylate co-polymer, wherein the carboxylate co-polymer comprises: (i) from 50 to less than 98 wt % structural units derived from one or more monomers comprising carboxyl groups; (ii) from 1 to less than 49 wt % structural units derived from one or more monomers comprising sulfonate moieties; and (iii) from 1 to 49 wt % structural units derived from one or more types of monomers selected from ether bond-containing monomers represented by formulas (I) and (II):

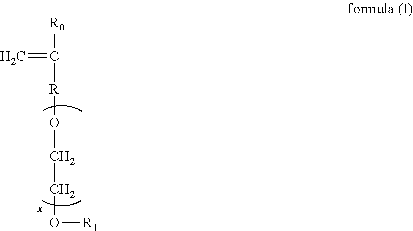

wherein in formula (I), R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group;

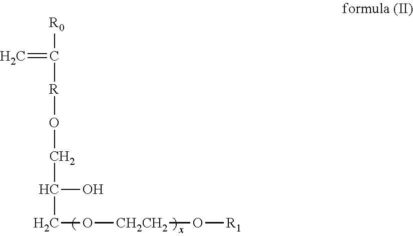

wherein in formula (II), R₀ represents a hydrogen atom or CH₃ group, R represents a CH₂ group, CH₂CH₂ group or single bond, X represents a number 0-5, and R₁ is a hydrogen atom or C₁ to C₂₀ organic group.

Typically, the base detergent particle comprises from 30 wt % to 70 wt % sodium sulphate.

Typically, the composition comprises from 1 wt % to 20 wt % co-surfactant particle, wherein the co-surfactant particle comprises: (a) from 25 wt % to 60 wt % co-surfactant; (b) from 10 wt % to 50 wt % carbonate salt; and (c) from 1 wt % to 30 wt % silica. Typically, the co-surfactant particle is in the form of an agglomerate.

Typically, the co-surfactant comprises alkyl ethoxylated sulphate having an average degree of ethoxylation of from 0.5 to 2.5, and wherein the co-surfactant particle comprises from 25 wt % to 60 wt % alkyl ethoxylated sulphate having an average degree of ethoxylation of from 0.5 to 2.5.

The co-surfactant particle may comprise linear alkyl benzene sulphonate and alkyl ethoxylated sulphate having an average degree of ethoxylation of from 0.5 to 2.5.

The composition at 1 wt % dilution in deionized water at 20° C., may have an equilibrium pH in the range of from 6.5 to 8.5.

The composition may have a reserve alkalinity to pH 7.5 of less than 3.0gNaOH/100 g.

The composition may comprise from 0 wt % to 6 wt %, preferably from 0 wt % to 4 wt %, sodium bicarbonate.

The composition may comprise from 0 wt % to 4 wt % sodium carbonate.

The composition may comprise from 0 wt % to 4 wt % sodium silicate.

The composition may comprise from 0 wt % to 4 wt % phosphate builder.

The composition is preferably substantially free of phosphate builder.

The composition may be substantially free of sodium carbonate.

The composition may be substantially free of sodium bicarbonate.

The composition may be substantially free of sodium silicate.

By “substantially free” it is typically meant herein to mean: “comprises no deliberately added”.

The composition may comprise the combination of lipase enzyme and soil release polymer.

Preferably, the composition comprises alkyl benzene sulphonate, wherein the alkyl benzene sulphonate comprises at least 25 wt % of the 2-phenyl isomer. A suitable alkyl benzene sulphonate having this feature is obtained by DETAL synthesis.

The composition may comprises alkyl amine oxide.

The composition may comprises from 0.5 wt % to 8 wt % carboxylate co-polymer, wherein the carboxylate co-polymer comprises: (i) from 50 to less than 98 wt % structural units derived from one or more monomers comprising carboxyl groups;

(ii) from 1 to less than 49 wt % structural units derived from one or more monomers comprising sulfonate moieties; and (iii) from 1 to 49 wt % structural units derived from one or more types of monomers selected from ether bond-containing monomers represented by formulas (I) and (II):

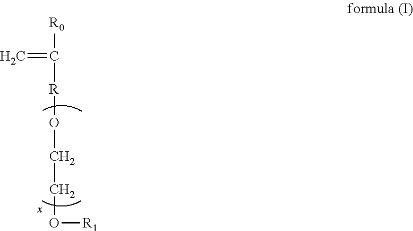

wherein in formula (I), R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group;

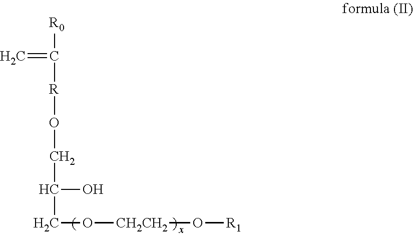

wherein in formula (II), R₀ represents a hydrogen atom or CH₃ group, R represents a CH₂ group, CH₂CH₂ group or single bond, X represents a number 0-5, and R₁ is a hydrogen atom or C₁ to C₂₀ organic group.

The composition may comprise polyethylene glycol polymer, wherein the polyethylene glycol polymer comprises a polyethylene glycol backbone with grafted polyvinyl acetate side chains.

The composition may comprise a polyester soil release polymer having the structure:

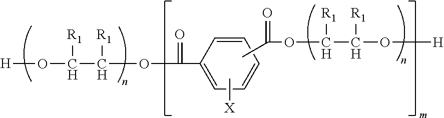

wherein n is from 1 to 10; m is from 1 to 15;

X is H or SO₃Me;

wherein Me is H, Na⁺, Li⁺, K⁺, Mg²⁺, Ca²⁺, Al³⁺, ammonium, mono-, di-, tri-, or tetra-alkylammonium; wherein the alkyl groups are C₁-C₁₈ alkyl or C₂-C₁₀ hydroxyalkyl, or any mixture thereof;

R1 are independently selected from H or C₁-C₁₈ n- or iso-alkyl.

The composition may comprise a polyester soil release polymer consisting of structure units (1) to (3):

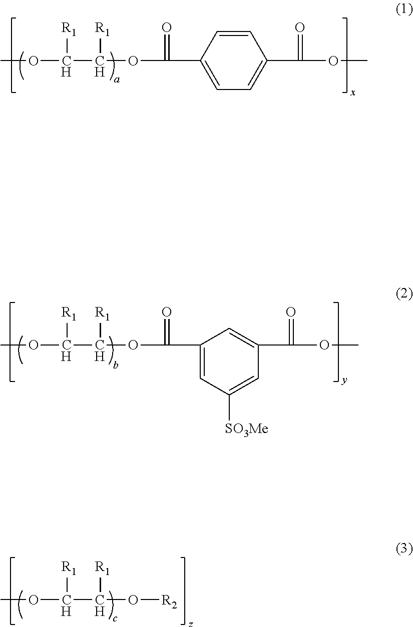

wherein:

a, b and c are from 1 to 10;

x, y is from 1 to 10;

z is from 0.1 to 10;

Me is H, Na⁺, Li⁺, K⁺, Mg²⁺, Ca²⁺, Al³⁺, ammonium, mono-, di-, tri-, or tetra-alkylammonium wherein the alkyl groups are C₁-C₁₈ alkyl or C₂-C₁₀ hydroxyalkyl, or any mixture thereof;

R₁, are independently selected from H or C₁-C₁₈ n- or iso-alkyl;

R₂ is a linear or branched C₁-Cis alkyl, or a linear or branched C₂-C₃₀ alkenyl, or a cycloalkyl group with 5 to 9 carbon atoms, or a C₆-C₃₀ aryl group, or a C₆-C₃₀ arylalkyl group.

The composition may comprise carboxymethyl cellulose having a degree of substitution greater than 0.65 and a degree of blockiness greater than 0.45.

The composition may comprise an alkoxylated polyalkyleneimine, wherein said alkoxylated polyalkyleneimine has a polyalkyleneimine core with one or more side chains bonded to at least one nitrogen atom in the polyalkyleneimine core, wherein said alkoxylated polyalkyleneimine has an empirical formula (I) of (PEI)ₐ-(EO)_{b}-R₁, wherein a is the average number-average molecular weight (MW_{PEI}) of the polyalkyleneimine core of the alkoxylated polyalkyleneimine and is in the range of from 100 to 100,000 Daltons, wherein b is the average degree of ethoxylation in said one or more side chains of the alkoxylated polyalkyleneimine and is in the range of from 5 to 40, and wherein R₁ is independently selected from the group consisting of hydrogen, C₁-C₄ alkyls, and combinations thereof.

The composition may comprise an alkoxylated polyalkyleneimine, wherein said alkoxylated polyalkyleneimine has a polyalkyleneimine core with one or more side chains bonded to at least one nitrogen atom in the polyalkyleneimine core, wherein the alkoxylated polyalkyleneimine has an empirical formula (II) of (PEI)ₒ-(EO)ₘ(PO)ₙ-R₂ or (PEI)ₒ-(PO)ₙ(EO)ₘ-R₂, wherein o is the average number-average molecular weight (MW_{PEI}) of the polyalkyleneimine core of the alkoxylated polyalkyleneimine and is in the range of from 100 to 100,000 Daltons, wherein m is the average degree of ethoxylation in said one or more side chains of the alkoxylated polyalkyleneimine which ranges from 10 to 50, wherein n is the average degree of propoxylation in said one or more side chains of the alkoxylated polyalkyleneimine which ranges from 1 to 50, and wherein R₂ is independently selected from the group consisting of hydrogen, C₁-C₄ alkyls, and combinations thereof.

The composition may comprise the combination of a non-ionic soil release polymer and an anionic soil release polymer.

Highly preferably, the composition is substantially free of pre-formed peracid.

The composition may comprise:
(a) from 1 wt % to 20 wt % sodium percarbonate;
(b) from 0.5 wt % to 5 wt % bleach activator; and
(c) from 0.5 wt % to 5 wt % chelant.

The bleach activator may comprise sodium tetraacetylethylenediamine, and wherein the composition may comprise from 0.5 wt % to 5 wt % sodium tetraacetylethylenediamine.

The chelant may comprise sodium salt of methylglycine diacetic acid (MGDA), and wherein the composition may comprise from 0.5 wt % to 5 wt % sodium salt of methylglycine diacetic acid (MGDA).

The chelant may comprise ethylenediamine disuccinic acid (EDDS), and wherein the composition may comprise from 0.5 wt % to 5 wt % ethylenediamine disuccinic acid (EDDS).

The chelant may comprise disodium 4,5-dihydroxy-1,3-benzenedisulfonate, and wherein the composition may comprise from 0.5 wt % to 5 wt % disodium 4,5-dihydroxy-1,3-benzenedisulfonate.

The composition may comprises 4,4′-bis-(triazinylamino)-stilbene-2,2′-disulfonic acid brightener and/or 4,4′-distyryl biphenyl brightener.

The composition may comprises an acyl hydrazone bleach catalyst, wherein the acyl hydrazone bleach catalyst has the formula I:

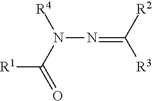

wherein, R¹ is selected from the groups comprising CF₃, C₁₋₂₈ alkyl, C₂₋₂₈ alkenyl, C₂₋₂₂ alkynyl, C₃₋₁₂ cycloalkyl, C₃₋₁₂ cycloalkenyl, phenyl, naphthyl, C₇₋₉ aralkyl, C₃₋₂₀ heteroalkyl, C₃₋₁₂ cycloheteroalkyl or a mixture thereof;
R² and R³ are independently selected from the group comprising hydrogen, substituted C₁-28 alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₈ heteroalkyl, C₃₋₁₂ cycloheteroalkyl, C₅₋₁₆ heteroaralkyl, phenyl, naphthyl, heteroaryl or a mixture thereof;
or R² and R³ are linked to form a substituted 5-, 6-, 7-, 8- or 9-membered ring that optionally comprises heteroatoms;
and R⁴ is selected from the groups comprising hydrogen, C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl, substituted phenyl, naphthyl, heteroaryl or a mixture thereof.

The composition may comprise a hueing agent having the following structure:

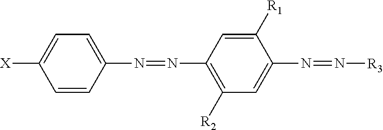

wherein:

R1 and R2 are independently selected from the group consisting of: H; alkyl; alkoxy; alkyleneoxy; alkyl capped alkyleneoxy; urea; and amido;

R3 is a substituted aryl group;

X is a substituted group comprising sulfonamide moiety and optionally an alkyl and/or aryl moiety, and wherein the substituent group comprises at least one alkyleneoxy chain that comprises an average molar distribution of at least four alkyleneoxy moieties.

The composition may comprise a hueing agent having the following structure:

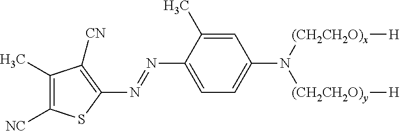

wherein the index values x and y are independently selected from 1 to 10.

The composition may comprise a hueing agent selected from Acid Violet 50, Direct Violet 9, 66 and 99, Solvent Violet 13 and any combination thereof.

The composition may comprise a protease having at least 90% identity to the amino acid sequence of Bacillus amyloliquefaciens as shown in SEQ ID NO:9

The composition may comprise a protease having at least 90% identity to the amino acid sequence of Bacillus amyloliquefaciens BPN′ as shown in SEQ ID NO:10, and which comprises one or more mutations selected from group consisting of V4I, S9R, A15T, S24G, S33T, S53G, V68A, N76D, S78N, S101M/N, Y167F, and Y217Q.

The composition may comprise a protease having at least 90% identity to the amino acid sequence of Bacillus thermoproteolyticus as shown in SEQ ID NO:11.

The composition may comprise a protease having at least 90% identity to the amino acid sequence of Bacillus lentus as shown in SEQ IS NO:12, and which comprises one or mutations selected from the group consisting of S3T, V4I, A194P, V199M, V205I, and L217D.

The composition may comprise a protease having at least 90% identity to the amino acid sequence of Bacillus sp. TY145 as shown in SEQ ID NO:13.

The composition may comprise a protease having at least 90% identity to the amino acid sequence of Bacillus sp. KSM-KP43 as shown in SEQ ID NO:14.

The composition may comprise a variant of the wild-type amylase from Bacillus sp. which has at least 90% identity for amino acid sequence SEQ ID NO:5, and which comprises one or more mutations at positions N195, G477, G304, W140, W189, D134, V206, Y243, E260, F262, W284, W347, W439, W469 and/or G476, and optionally which comprises the deletions of D183* and/or G184*.

The composition may comprise a variant of the wild-type amylase from Bacillus sp. which has at least 90% identity for amino acid sequence SEQ ID NO:6, and which comprises one or more mutations at positions 9, 26, 30, 33, 82, 37, 106, 118, 128, 133, 149, 150, 160, 178, 182, 186, 193, 195, 202, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482 and/or 484, preferably that also contain the deletions of D183* and G184*.

The composition may comprise a variant of the wild-type amylase from Bacillus sp. KSM-K38 which has at least 90% identity for amino acid sequence SEQ ID NO:7.

The composition may comprise a variant of the wild-type amylase from Cytophaga sp. which has at least 60% identity for amino acid sequence SEQ ID NO:8.

The composition may comprise a variant of the wild-type lipase from Thermomyces lanuginosus which has at least 90% identity for amino acid sequence SEQ ID NO:1.

The composition may comprise a variant of the wild-type lipase from Thermomyces lanuginosus which has at least 90% identity for amino acid sequence SEQ ID NO:1, and which comprises T231R and/or N233R mutations.

The composition may comprise a variant of the wild-type lipase from Thermomyces lanuginosus which has at least 90% identity for amino acid sequence SEQ ID NO:1, and which comprises G91A, D96G, G225R, T231R and/or N233R mutations.

the composition may comprise a cellulase that is a wild-type or variant of a microbially-derived endoglucanase endogenous to Bacillus sp. exhibiting endo-beta-1,4-glucanase activity (E.C. 3.2.1.4) which has at least 90% identity to the amino acid sequence SEQ ID NO:2.

The composition may comprise cellulase that is a wild-type or variant of a microbially-derived endoglucanase endogenous to Paenibacillus polymyxa exhibiting endo-beta-1,4-glucanase activity (E.C. 3.2.1.4) which has at least 90% identity to amino acid sequence SEQ ID NO:3.

The composition may comprise a cellulase that is a hybrid fusion endoglucanase comprising a Glycosyl Hydrolase Family 45 catalytic domain that is a wild-type or variant of a microbially-derived endoglucanase endogenous to Melanocarpus albomyces, and a carbohydrate binding module that is a wild-type or variant of a carbohydrate binding module endogenous to Trichoderma reesei, and which has at least 90% identity to amino acid sequence SEQ ID NO:4.

The composition may comprise an enzyme selected from mannanase, pectate lyase, laccase, polyesterase, galactanase, acyltransferase, and any combination thereof.

The composition may comprise a perfume, wherein the perfume comprises from 60 wt % to 85 wt % ester perfume raw materials having the structure:

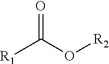

wherein R1 and R2 are independently selected from C1 to C30 linear or branched, cyclic or non-cyclic, aromatic or non-aromatic, saturated or un-saturated, substituted or unsubstituted alkyl.

The composition may comprise: (a) alkyl ethoxylated sulphate having an average degree of ethoxylation of from 0.5 to 2.0; (b) perfume, wherein the perfume comprises from 60 wt % to 85 wt % ester perfume raw materials having the structure:

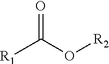

wherein R1 and R2 are independently selected from C1 to C30 linear or branched, cyclic or non-cyclic, aromatic or non-aromatic, saturated or un-saturated, substituted or unsubstituted alkyl.

The composition may comprise polyvinyl N oxide polymer.

The composition may comprise: silicate salt particles, especially sodium silicate particles; and/or carbonate salt particles, especially sodium bicarbonate particles. However it may be preferred for the composition to be free of silicate salt particles, especially free of sodium silicate particles. It may also be preferred for the composition to be free of carbonate salt particles, especially free of sodium carbonate particles.

Preferably, the composition comprises from 1 wt % to 10 wt % dry-added acid particles, preferably from 2 wt % to 8 wt % dry-added acid particles. A suitable dry-added acid is an organic acid, preferably a carboxylic acid, preferably cirtric acid.

Base Detergent Particle:

The solid free-flowing particulate laundry detergent composition typically comprises a base detergent particle. The base detergent particle may be in the form of spray-dried particle, or an agglomerate, preferably the base particle is in the form of a spray-dried particle. Typically, the composition comprises from 30 wt % to 90 wt % base detergent particle, preferably from 40 wt % to 80 wt %, more preferably from 50 wt % to 70 wt % base detergent particle.

The base detergent particle typically comprises from 1 wt % to 10 wt % organic acid, preferably from 2 wt % to 8 wt %, or from 3 wt % to 7 wt % organic acid. A preferred organic acid is a carboxylic acid, preferably citric acid.

The base detergent particle typically comprises from 1 wt % to 10 wt % magnesium sulphate, preferably from 2 wt % to 8 wt %, or from 3 wt % to 6 wt % magnesium sulphate.

The base detergent particle typically comprises from 1 wt % to 8 wt %, preferably from 2 wt % to 6 wt % or from 2 wt % to 4 wt % zeolite. A preferred zeolite is zeolite A, especially zeolite 4A.

The base detergent particle typically comprises from 5 wt % to 40 wt %, preferably from 10 wt % to 30 wt % anionic detersive surfactant. A preferred anionic detersive surfactant is alkyl benzene sulphonate.

The base detergent particle typically comprises from 0.5 wt % to 5 wt % polymer, preferably from 1 wt % to 3 wt % polymer. A preferred polymer is a carboxylate polymer, more preferably a co-polymer that comprises: (i) from 50 to less than 98 wt % structural units derived from one or more monomers comprising carboxyl groups; (ii) from 1 to less than 49 wt % structural units derived from one or more monomers comprising sulfonate moieties; and (iii) from 1 to 49 wt % structural units derived from one or more types of monomers selected from ether bond-containing monomers represented by formulas (I) and (II):

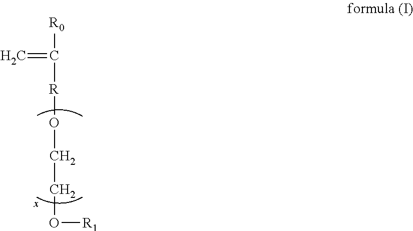

wherein in formula (I), R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group;

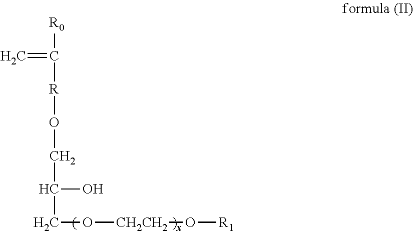

wherein in formula (II), R₀ represents a hydrogen atom or CH₃ group, R represents a CH₂ group, CH₂CH₂ group or single bond, X represents a number 0-5, and R₁ is a hydrogen atom or C₁ to C₂₀ organic group.

It may be preferred that the polymer has a weight average molecular weight of at least 50 kDa, or even at least 70 kDa.

Typically, the base detergent particle comprises from 30 wt % to 70 wt %, or from 40 wt % to 70 wt % sodium sulphate.

Co-Surfactant Particle:

Typically, the detergent composition comprises a co-surfactant particle. Typically, the composition comprises from 1 wt % to 20 wt %, or from 2 wt % to 15 wt %, or from 3 wt % to 10 wt % co-surfactant particle. Typically, the co-surfactant particle is in the form of an agglomerate, extrudate, needle, noodle, flake or any combination thereof. Preferably, the co-surfactant particle is in the form of an agglomerate.

The co-surfactant particle typically comprises from 25 wt % to 60 wt % co-surfactant, preferably from 30 wt % to 50 wt % co-surfactant. A preferred co-surfactant is alkyl alkoxy sulphate, preferably a C₁₀-C₂₀ alkyl ethoxylated sulphate having an average degree of ethoxylation of from 0.5 to 2.0.

Typically, the co-surfactant particle comprises from 10 wt % to 50 wt % carbonate salt. A preferred carbonate salt is sodium carbonate and/or sodium bicarbonate. However, it may be preferred for the co-surfactant particle to be free of carbonate salt, especially free of sodium carbonate.

Typically, the co-surfactant particle comprises from 1 wt % to 30 wt % silica, preferably from 5 wt % to 20 wt % silica.

Detergent Ingredients:

Suitable laundry detergent compositions comprise a detergent ingredient selected from: detersive surfactant, such as anionic detersive surfactants, non-ionic detersive surfactants, cationic detersive surfactants, zwitterionic detersive surfactants and amphoteric detersive surfactants; polymers, such as carboxylate polymers, soil release polymer, anti-redeposition polymers, cellulosic polymers and care polymers; bleach, such as sources of hydrogen peroxide, bleach activators, bleach catalysts and pre-formed peracids; photobleach, such as such as zinc and/or aluminium sulphonated phthalocyanine; enzymes, such as proteases, amylases, cellulases, lipases; zeolite builder; phosphate builder; co-builders, such as citric acid and citrate; sulphate salt, such as sodium sulphate; chloride salt, such as sodium chloride; brighteners; chelants; hueing agents; dye transfer inhibitors; dye fixative agents; perfume; silicone; fabric softening agents, such as clay; flocculants, such as polyethyleneoxide; suds supressors; and any combination thereof.

The composition may comprise: silicate salt, especially sodium silicate; and/or carbonate salt, especially sodium bicarbonate and/or sodium carbonate. However it may be preferred for the composition to be free of silicate salt, especially free of sodium silicate. It may also be preferred for the composition to be free of carbonate salt, especially free of sodium carbonate and/or sodium bicarbonate.

The composition may have a pH profile such that upon dilution in de-ionized water at a concentration of 1 g/L at a temperature of 20° C. the composition has a pH in the range of from 6.5 to 8.5, preferably from 7.0 to 8.0.

Suitable laundry detergent compositions may have a low buffering capacity. Such laundry detergent compositions typically have a reserve alkalinity to pH 7.5 of less than 5.0gNaOH/100 g, preferably less than 3.0gNaOH/100 g.

The composition is preferably substantially free of pre-formed peracid. The composition is preferably substantially free of phthalimido-peroxycaproic acid. Substantially free means no deliberately added.

Detersive Surfactant:

Suitable detersive surfactants include anionic detersive surfactants, non-ionic detersive surfactant, cationic detersive surfactants, zwitterionic detersive surfactants and amphoteric detersive surfactants. Suitable detersive surfactants may be linear or branched, substituted or un-substituted, and may be derived from petrochemical material or biomaterial.

Anionic detersive surfactant:

Suitable anionic detersive surfactants include sulphonate and sulphate detersive surfactants.

Suitable sulphonate detersive surfactants include methyl ester sulphonates, alpha olefin sulphonates, alkyl benzene sulphonates, especially alkyl benzene sulphonates, preferably C₁₀₋₁₃ alkyl benzene sulphonate. Suitable alkyl benzene sulphonate (LAS) is obtainable, preferably obtained, by sulphonating commercially available linear alkyl benzene (LAB); suitable LAB includes low 2-phenyl LAB, other suitable LAB include high 2-phenyl LAB, such as those supplied by Sasol under the tradename Hyblene®.

Suitable sulphate detersive surfactants include alkyl sulphate, preferably C₈₋₁₈ alkyl sulphate, or predominantly C₁₂ alkyl sulphate.

A preferred sulphate detersive surfactant is alkyl alkoxylated sulphate, preferably alkyl ethoxylated sulphate, preferably a C₈₋₁₈ alkyl alkoxylated sulphate, preferably a C₈₋₁₈ alkyl ethoxylated sulphate, preferably the alkyl alkoxylated sulphate has an average degree of alkoxylation of from 0.5 to 20, preferably from 0.5 to 10, preferably the alkyl alkoxylated sulphate is a C₈₋₁₈ alkyl ethoxylated sulphate having an average degree of ethoxylation of from 0.5 to 10, preferably from 0.5 to 5, more preferably from 0.5 to 3 and most preferably from 0.5 to 1.5.

The alkyl sulphate, alkyl alkoxylated sulphate and alkyl benzene sulphonates may be linear or branched, substituted or un-substituted, and may be derived from petrochemical material or biomaterial.

Other suitable anionic detersive surfactants include alkyl ether carboxylates.

Suitable anionic detersive surfactants may be in salt form, suitable counter-ions include sodium, calcium, magnesium, amino alcohols, and any combination thereof. A preferred counter-ion is sodium.

Non-Ionic Detersive Surfactant:

Suitable non-ionic detersive surfactants are selected from the group consisting of: C₈-C₁₈ alkyl ethoxylates, such as, NEODOL® non-ionic surfactants from Shell; C₆-C₁₂ alkyl phenol alkoxylates wherein preferably the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; alkylpolysaccharides, preferably alkylpolyglycosides; methyl ester ethoxylates; polyhydroxy fatty acid amides; ether capped poly(oxyalkylated) alcohol surfactants; and mixtures thereof.

Suitable non-ionic detersive surfactants are alkylpolyglucoside and/or an alkyl alkoxylated alcohol.

Suitable non-ionic detersive surfactants include alkyl alkoxylated alcohols, preferably C₈₋₁₈ alkyl alkoxylated alcohol, preferably a C₈₋₁₈ alkyl ethoxylated alcohol, preferably the alkyl alkoxylated alcohol has an average degree of alkoxylation of from 1 to 50, preferably from 1 to 30, or from 1 to 20, or from 1 to 10, preferably the alkyl alkoxylated alcohol is a C₈₋₁₈ alkyl ethoxylated alcohol having an average degree of ethoxylation of from 1 to 10, preferably from 1 to 7, more preferably from 1 to 5 and most preferably from 3 to 7. The alkyl alkoxylated alcohol can be linear or branched, and substituted or un-substituted.

Suitable nonionic detersive surfactants include secondary alcohol-based detersive surfactants.

Cationic Detersive Surfactant:

Suitable cationic detersive surfactants include alkyl pyridinium compounds, alkyl quaternary ammonium compounds, alkyl quaternary phosphonium compounds, alkyl ternary sulphonium compounds, and mixtures thereof.

Preferred cationic detersive surfactants are quaternary ammonium compounds having the general formula:

(R)(R₁)(R₂)(R₃)N⁺X⁻

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, preferred anions include: halides, preferably chloride; sulphate; and sulphonate.

Zwitterionic Detersive Surfactant:

Suitable zwitterionic detersive surfactants include amine oxides and/or betaines.

Polymer:

Suitable polymers include carboxylate polymers, soil release polymers, anti-redeposition polymers, cellulosic polymers, care polymers and any combination thereof.

Carboxylate Polymer:

The composition may comprise a carboxylate polymer, such as a maleate/acrylate random copolymer or polyacrylate homopolymer. Suitable carboxylate polymers include: polyacrylate homopolymers having a molecular weight of from 4,000 Da to 9,000 Da; maleate/acrylate random copolymers having a molecular weight of from 50,000 Da to 100,000 Da, or from 60,000 Da to 80,000 Da.

Another suitable carboxylate polymer is a co-polymer that comprises: (i) from 50 to less than 98 wt % structural units derived from one or more monomers comprising carboxyl groups; (ii) from 1 to less than 49 wt % structural units derived from one or more monomers comprising sulfonate moieties; and (iii) from 1 to 49 wt % structural units derived from one or more types of monomers selected from ether bond-containing monomers represented by formulas (I) and (II):

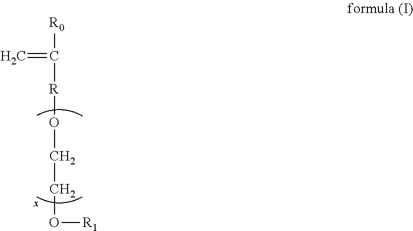

wherein in formula (I), R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group;

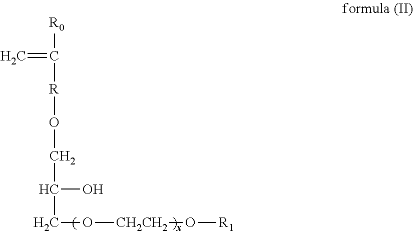

wherein in formula (II), R₀ represents a hydrogen atom or CH₃ group, R represents a CH₂ group, CH₂CH₂ group or single bond, X represents a number 0-5, and R₁ is a hydrogen atom or C₁ to C₂₀ organic group.

It may be preferred that the polymer has a weight average molecular weight of at least 50 kDa, or even at least 70 kDa.

Soil Release Polymer:

The composition may comprise a soil release polymer. A suitable soil release polymer has a structure as defined by one of the following structures (I), (II) or (III):

—[(OCHR¹—CHR²)ₐ—O—OC—Ar—CO—]_{d} (I)

—[(OCHR₃—CHR₄)_{b}—O—OC-sAr—CO—]ₑ (II)

—[(OCHR⁵—CHR⁶)ₑ—OR⁷]_{f} (III)

wherein:

a, b and c are from 1 to 200;

d, e and f are from 1 to 50;

Ar is a 1,4-substituted phenylene;

sAr is 1,3-substituted phenylene substituted in position 5 with SO₃Me;

Me is Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;

R¹, R², R³, R⁴, R⁵ and R⁶ are independently selected from H or C₁-C₁₈ n- or iso-alkyl; and

R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

Suitable soil release polymers are sold by Clariant under the TexCare® series of polymers, e.g. TexCare® SRN240 and TexCare® SRA300. Other suitable soil release polymers are sold by Solvay under the Repel-o-Tex® series of polymers, e.g. Repel-o-Tex® SF2 and Repel-o-Tex® Crystal.

Anti-Redeposition Polymer:

Suitable anti-redeposition polymers include polyethylene glycol polymers and/or polyethyleneimine polymers.

Suitable polyethylene glycol polymers include random graft co-polymers comprising: (i) hydrophilic backbone comprising polyethylene glycol; and (ii) hydrophobic side chain(s) selected from the group consisting of: C₄-C₂₅ alkyl group, polypropylene, polybutylene, vinyl ester of a saturated C₁-C₆ mono-carboxylic acid, C₁-C₆ alkyl ester of acrylic or methacrylic acid, and mixtures thereof. Suitable polyethylene glycol polymers have a polyethylene glycol backbone with random grafted polyvinyl acetate side chains. The average molecular weight of the polyethylene glycol backbone can be in the range of from 2,000 Da to 20,000 Da, or from 4,000 Da to 8,000 Da. The molecular weight ratio of the polyethylene glycol backbone to the polyvinyl acetate side chains can be in the range of from 1:1 to 1:5, or from 1:1.2 to 1:2. The average number of graft sites per ethylene oxide units can be less than 1, or less than 0.8, the average number of graft sites per ethylene oxide units can be in the range of from 0.5 to 0.9, or the average number of graft sites per ethylene oxide units can be in the range of from 0.1 to 0.5, or from 0.2 to 0.4. A suitable polyethylene glycol polymer is Sokalan HP22. Suitable polyethylene glycol polymers are described in WO08/007320.

Cellulosic Polymer:

Suitable cellulosic polymers are selected from alkyl cellulose, alkyl alkoxyalkyl cellulose, carboxyalkyl cellulose, alkyl carboxyalkyl cellulose, sulphoalkyl cellulose, more preferably selected from carboxymethyl cellulose, methyl cellulose, methyl hydroxyethyl cellulose, methyl carboxymethyl cellulose, and mixtures thereof.

Suitable carboxymethyl celluloses have a degree of carboxymethyl substitution from 0.5 to 0.9 and a molecular weight from 100,000 Da to 300,000 Da.

Suitable carboxymethyl celluloses have a degree of substitution greater than 0.65 and a degree of blockiness greater than 0.45, e.g. as described in WO09/154933.

Care Polymers:

Suitable care polymers include cellulosic polymers that are cationically modified or hydrophobically modified. Such modified cellulosic polymers can provide anti-abrasion benefits and dye lock benefits to fabric during the laundering cycle. Suitable cellulosic polymers include cationically modified hydroxyethyl cellulose.

Other suitable care polymers include dye lock polymers, for example the condensation oligomer produced by the condensation of imidazole and epichlorhydrin, preferably in ratio of 1:4:1. A suitable commercially available dye lock polymer is Polyquart® FDI (Cognis).

Other suitable care polymers include amino-silicone, which can provide fabric feel benefits and fabric shape retention benefits.

Bleach:

Suitable bleach includes sources of hydrogen peroxide, bleach activators, bleach catalysts, pre-formed peracids and any combination thereof. A particularly suitable bleach includes a combination of a source of hydrogen peroxide with a bleach activator and/or a bleach catalyst.

Source of Hydrogen Peroxide:

Suitable sources of hydrogen peroxide include sodium perborate and/or sodium percarbonate.

Bleach Activator:

Suitable bleach activators include tetra acetyl ethylene diamine and/or alkyl oxybenzene sulphonate.

Bleach Catalyst:

The composition may comprise a bleach catalyst. Suitable bleach catalysts include oxaziridinium bleach catalysts, transition metal bleach catalysts, especially manganese and iron bleach catalysts. A suitable bleach catalyst has a structure corresponding to general formula below:

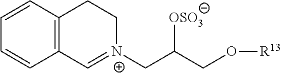

wherein R¹³ is selected from the group consisting of 2-ethylhexyl, 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl.

Pre-Formed Peracid:

Suitable pre-form peracids include phthalimido-peroxycaproic acid. However, it is preferred that the composition is substantially free of pre-formed peracid. By:

“substantially free” it is meant: “no deliberately added”.

Enzymes:

Suitable enzymes include lipases, proteases, cellulases, amylases and any combination thereof.

Protease:

Suitable proteases include metalloproteases and/or serine proteases. Examples of suitable neutral or alkaline proteases include: subtilisins (EC 3.4.21.62); trypsin-type or chymotrypsin-type proteases; and metalloproteases. The suitable proteases include chemically or genetically modified mutants of the aforementioned suitable proteases.

Suitable commercially available protease enzymes include those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase® and Esperase® by Novozymes A/S (Denmark), those sold under the tradename Maxatase®, Maxacal®, Maxapem®, Preferenz P® series of proteases including Preferenz® P280, Preferenz® P281, Preferenz® P2018-C, Preferenz® P2081-WE, Preferenz® P2082-EE and Preferenz® P2083-A/J, Properase®, Purafect®, Purafect Prime®, Purafect Ox®, FN3®, FN4®, Excellase® and Purafect OXP® by DuPont, those sold under the tradename Opticlean® and Optimase® by Solvay Enzymes, those available from Henkel/Kemira, namely BLAP (sequence shown in FIG. 29 of U.S. Pat. No. 5,352,604 with the following mutations S99D+S101 R+S103A+V104I+G159S, hereinafter referred to as BLAP), BLAP R (BLAP with S3T+V4I+V199M+V205I+L217D), BLAP X (BLAP with S3T+V4I+V205I) and BLAP F49 (BLAP with S3T+V4I+A194P+V199M+V205I+L217D)—all from Henkel/Kemira; and KAP (Bacillus alkalophilus subtilisin with mutations A230V+S256G+S259N) from Kao.

A suitable protease is described in WO11/140316 and WO11/072117.

Amylase:

Suitable amylases are derived from AA560 alpha amylase endogenous to Bacillus sp. DSM 12649, preferably having the following mutations: R118K, D183*, G184*, N195F, R320K, and/or R458K. Suitable commercially available amylases include Stainzyme®, Stainzyme® Plus, Natalase, Termamyl®, Termamyl® Ultra, Liquezyme® SZ, Duramyl®, Everest® (all Novozymes) and Spezyme® AA, Preferenz S® series of amylases, Purastar® and Purastar® Ox Am, Optisize® HT Plus (all Du Pont).

A suitable amylase is described in WO06/002643.

Cellulase: Suitable cellulases include those of bacterial or fungal origin. Chemically modified or protein engineered mutants are also suitable. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum.

Commercially available cellulases include Celluzyme®, Carezyme®, and Carezyme® Premium, Celluclean® and Whitezyme® (Novozymes A/S), Revitalenz® series of enzymes (Du Pont), and Biotouch® series of enzymes (AB Enzymes). Suitable commercially available cellulases include Carezyme® Premium, Celluclean® Classic. Suitable cellulases are described in WO07/144857 and WO10/056652.

Lipase:

Suitable lipases include those of bacterial, fungal or synthetic origin, and variants thereof. Chemically modified or protein engineered mutants are also suitable. Examples of suitable lipases include lipases from Humicola (synonym Thermomyces), e.g., from H. lanuginosa (T. lanuginosus).

The lipase may be a “first cycle lipase”, e.g. such as those described in WO06/090335 and WO13/116261. In one aspect, the lipase is a first-wash lipase, preferably a variant of the wild-type lipase from Thermomyces lanuginosus comprising T231R and/or N233R mutations. Preferred lipases include those sold under the tradenames Lipex®, Lipolex® and Lipoclean® by Novozymes, Bagsvaerd, Denmark.

Other suitable lipases include: Liprl 139, e.g. as described in WO2013/171241; and TfuLip2, e.g. as described in WO2011/084412 and WO2013/033318.

Other Enzymes:

Other suitable enzymes are bleaching enzymes, such as peroxidases/oxidases, which include those of plant, bacterial or fungal origin and variants thereof. Commercially available peroxidases include Guardzyme® (Novozymes A/S). Other suitable enzymes include choline oxidases and perhydrolases such as those used in Gentle Power Bleach™.

Other suitable enzymes include pectate lyases sold under the tradenames X-Pect®, Pectaway® (from Novozymes A/S, Bagsvaerd, Denmark) and PrimaGreen® (DuPont) and mannanases sold under the tradenames Mannaway® (Novozymes A/S, Bagsvaerd, Denmark), and Mannastar® (Du Pont).

Identity:

When used herein identity or sequence identity refers to the relatedness between two amino acid sequences.

For purposes of the present invention, the degree of sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 3.0.0 or later. The optional parameters used are gap open penalty of 10, gap extension penalty of 0.5, and the EBLOSUM62 (EMBOSS version of BLOSUM62) substitution matrix. The output of Needle labeled “longest identity” (obtained using the—nobrief option) is used as the percent identity and is calculated as follows:

(Identical Residues×100)/(Length of Alignment−Total Number of Gaps in Alignment)

Zeolite Builder:

The composition may comprise zeolite builder. The composition may comprise from 0 wt % to 5 wt % zeolite builder, or 3 wt % zeolite builder. The composition may even be substantially free of zeolite builder; substantially free means “no deliberately added”. Typical zeolite builders include zeolite A, zeolite P and zeolite MAP.

Phosphate Builder:

The composition may comprise phosphate builder. The composition may comprise from 0 wt % to 5 wt % phosphate builder, or to 3 wt %, phosphate builder. The composition may even be substantially free of phosphate builder; substantially free means “no deliberately added”. A typical phosphate builder is sodium tri-polyphosphate.

Carbonate Salt:

The composition may comprise carbonate salt. The composition may comprise from 0 wt % to 5 wt % carbonate salt. The composition may even be substantially free of carbonate salt; substantially free means “no deliberately added”. Suitable carbonate salts include sodium carbonate and sodium bicarbonate.

Silicate Salt:

The composition may comprise silicate salt. The composition may comprise from 0 wt % to 5 wt % silicate salt. The composition may even be substantially free of silicate salt; substantially free means “no deliberately added”. A preferred silicate salt is sodium silicate, especially preferred are sodium silicates having a Na₂O:SiO₂ ratio of from 1.0 to 2.8, preferably from 1.6 to 2.0.

Sulphate Salt:

A suitable sulphate salt is sodium sulphate.

Brightener:

Suitable fluorescent brighteners include: di-styryl biphenyl compounds, e.g. Tinopal® CBS-X, di-amino stilbene di-sulfonic acid compounds, e.g. Tinopal® DMS pure Xtra and Blankophor® HRH, and Pyrazoline compounds, e.g. Blankophor® SN, and coumarin compounds, e.g. Tinopal® SWN.

Preferred brighteners are: sodium 2 (4-styryl-3-sulfophenyl)-2H-napthol[1,2-d]triazole, disodium 4,4′-bis{[(4-anilino-6-(N methyl-N-2 hydroxyethyl)amino 1,3,5-triazin-2-yl)]amino}stilbene-2-2′ disulfonate, disodium 4,4′-bis{[(4-anilino-6-morpholino-1,3,5-triazin-2-yl)]amino}stilbene-2-2′ disulfonate, and disodium 4,4′-bis(2-sulfostyryl)biphenyl. A suitable fluorescent brightener is C.I. Fluorescent Brightener 260, which may be used in its beta or alpha crystalline forms, or a mixture of these forms.

Chelant:

The composition may also comprise a chelant selected from: diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid) and hydroxyethane di(methylene phosphonic acid). A preferred chelant is ethylene diamine-N′N′-disuccinic acid (EDDS) and/or hydroxyethane diphosphonic acid (HEDP). The composition preferably comprises ethylene diamine-N′N′-disuccinic acid or salt thereof. Preferably the ethylene diamine-N′N′-disuccinic acid is in S,S enantiomeric form. Preferably the composition comprises 4,5-dihydroxy-m-benzenedisulfonic acid disodium salt. Preferred chelants may also function as calcium carbonate crystal growth inhibitors such as: 1-hydroxyethanediphosphonic acid (HEDP) and salt thereof; N,N-dicarboxymethyl-2-aminopentane-1,5-dioic acid and salt thereof; 2-phosphonobutane-1,2,4-tricarboxylic acid and salt thereof; and combination thereof.

Hueing Agent:

Suitable hueing agents include small molecule dyes, typically falling into the Colour Index (C.I.) classifications of Acid, Direct, Basic, Reactive (including hydrolysed forms thereof) or Solvent or Disperse dyes, for example classified as Blue, Violet, Red, Green or Black, and provide the desired shade either alone or in combination. Preferred such hueing agents include Acid Violet 50, Direct Violet 9, 66 and 99, Solvent Violet 13 and any combination thereof.

Many hueing agents are known and described in the art which may be suitable for the present invention, such as hueing agents described in WO2014/089386.

Suitable hueing agents include phthalocyanine and azo dye conjugates, such as described in WO2009/069077.

Suitable hueing agents may be alkoxylated. Such alkoxylated compounds may be produced by organic synthesis that may produce a mixture of molecules having different degrees of alkoxylation. Such mixtures may be used directly to provide the hueing agent, or may undergo a purification step to increase the proportion of the target molecule. Suitable hueing agents include alkoxylated bis-azo dyes, such as described in WO2012/054835, and/or alkoxylated thiophene azo dyes, such as described in WO2008/087497 and WO2012/166768.

The hueing agent may be incorporated into the detergent composition as part of a reaction mixture which is the result of the organic synthesis for a dye molecule, with optional purification step(s). Such reaction mixtures generally comprise the dye molecule itself and in addition may comprise un-reacted starting materials and/or by-products of the organic synthesis route. Suitable hueing agents can be incorporated into hueing dye particles, such as described in WO 2009/069077.

Dye Transfer Inhibitors:

Suitable dye transfer inhibitors include polyamine N-oxide polymers, copolymers of N-vinylpyrrolidone and N-vinylimidazole, polyvinylpyrrolidone, polyvinyloxazolidone, polyvinylimidazole and mixtures thereof. Preferred are poly(vinyl pyrrolidone), poly(vinylpyridine betaine), poly(vinylpyridine N-oxide), poly(vinyl pyrrolidone-vinyl imidazole) and mixtures thereof. Suitable commercially available dye transfer inhibitors include PVP-K15 and K30 (Ashland), Sokalan® HP165, HP50, HP53, HP59, HP56K, HP56, HP66 (BASF), Chromabond® S-400, 5403E and S-100 (Ashland).

Perfume:

Suitable perfumes comprise perfume materials selected from the group: (a) perfume materials having a ClogP of less than 3.0 and a boiling point of less than 250° C. (quadrant 1 perfume materials); (b) perfume materials having a ClogP of less than 3.0 and a boiling point of 250° C. or greater (quadrant 2 perfume materials); (c) perfume materials having a ClogP of 3.0 or greater and a boiling point of less than 250° C. (quadrant 3 perfume materials); (d) perfume materials having a ClogP of 3.0 or greater and a boiling point of 250° C. or greater (quadrant 4 perfume materials); and (e) mixtures thereof.

It may be preferred for the perfume to be in the form of a perfume delivery technology. Such delivery technologies further stabilize and enhance the deposition and release of perfume materials from the laundered fabric. Such perfume delivery technologies can also be used to further increase the longevity of perfume release from the laundered fabric. Suitable perfume delivery technologies include: perfume microcapsules, pro-perfumes, polymer assisted deliveries, molecule assisted deliveries, fiber assisted deliveries, amine assisted deliveries, cyclodextrin, starch encapsulated accord, zeolite and other inorganic carriers, and any mixture thereof. A suitable perfume microcapsule is described in WO2009/101593.

Silicone:

Suitable silicones include polydimethylsiloxane and amino-silicones. Suitable silicones are described in WO05075616.

Process for Making the Solid Composition:

Typically, the particles of the composition can be prepared by any suitable method. For example: spray-drying, agglomeration, extrusion and any combination thereof.

Typically, a suitable spray-drying process comprises the step of forming an aqueous slurry mixture, transferring it through at least one pump, preferably two pumps, to a pressure nozzle. Atomizing the aqueous slurry mixture into a spray-drying tower and drying the aqueous slurry mixture to form spray-dried particles. Preferably, the spray-drying tower is a counter-current spray-drying tower, although a co-current spray-drying tower may also be suitable.

Typically, the spray-dried powder is subjected to cooling, for example an air lift. Typically, the spray-drying powder is subjected to particle size classification, for example a sieve, to obtain the desired particle size distribution. Preferably, the spray-dried powder has a particle size distribution such that weight average particle size is in the range of from 300 micrometers to 500 micrometers, and less than 10 wt % of the spray-dried particles have a particle size greater than 2360 micrometers.

It may be preferred to heat the aqueous slurry mixture to elevated temperatures prior to atomization into the spray-drying tower, such as described in WO2009/158162.

It may be preferred for anionic surfactant, such as linear alkyl benzene sulphonate, to be introduced into the spray-drying process after the step of forming the aqueous slurry mixture: for example, introducing an acid precursor to the aqueous slurry mixture after the pump, such as described in WO 09/158449.

It may be preferred for a gas, such as air, to be introduced into the spray-drying process after the step of forming the aqueous slurry, such as described in WO2013/181205.

It may be preferred for any inorganic ingredients, such as sodium sulphate and sodium carbonate, if present in the aqueous slurry mixture, to be micronized to a small particle size such as described in WO2012/134969.

Typically, a suitable agglomeration process comprises the step of contacting a detersive ingredient, such as a detersive surfactant, e.g. linear alkyl benzene sulphonate (LAS) and/or alkyl alkoxylated sulphate, with an inorganic material, such as sodium carbonate and/or silica, in a mixer. The agglomeration process may also be an in-situ neutralization agglomeration process wherein an acid precursor of a detersive surfactant, such as LAS, is contacted with an alkaline material, such as carbonate and/or sodium hydroxide, in a mixer, and wherein the acid precursor of a detersive surfactant is neutralized by the alkaline material to form a detersive surfactant during the agglomeration process.

Other suitable detergent ingredients that may be agglomerated include polymers, chelants, bleach activators, silicones and any combination thereof.

The agglomeration process may be a high, medium or low shear agglomeration process, wherein a high shear, medium shear or low shear mixer is used accordingly. The agglomeration process may be a multi-step agglomeration process wherein two or more mixers are used, such as a high shear mixer in combination with a medium or low shear mixer. The agglomeration process can be a continuous process or a batch process.

It may be preferred for the agglomerates to be subjected to a drying step, for example to a fluid bed drying step. It may also be preferred for the agglomerates to be subjected to a cooling step, for example a fluid bed cooling step.

Typically, the agglomerates are subjected to particle size classification, for example a fluid bed elutriation and/or a sieve, to obtain the desired particle size distribution. Preferably, the agglomerates have a particle size distribution such that weight average particle size is in the range of from 300 micrometers to 800 micrometers, and less than 10 wt % of the agglomerates have a particle size less than 150 micrometers and less than 10 wt % of the agglomerates have a particle size greater than 1200 micrometers.

It may be preferred for fines and over-sized agglomerates to be recycled back into the agglomeration process. Typically, over-sized particles are subjected to a size reduction step, such as grinding, and recycled back into an appropriate place in the agglomeration process, such as the mixer. Typically, fines are recycled back into an appropriate place in the agglomeration process, such as the mixer.

It may be preferred for ingredients such as polymer and/or non-ionic detersive surfactant and/or perfume to be sprayed onto base detergent particles, such as spray-dried base detergent particles and/or agglomerated base detergent particles. Typically, this spray-on step is carried out in a tumbling drum mixer.

Method of Laundering Fabric:

The method of laundering fabric comprises the step of contacting the solid composition to water to form a wash liquor, and laundering fabric in said wash liquor. Typically, the wash liquor has a temperature of above 0° C. to 90° C., or to 60° C., or to 40° C., or to 30° C., or to 20° C. The fabric may be contacted to the water prior to, or after, or simultaneous with, contacting the solid composition with water. Typically, the wash liquor is formed by contacting the laundry detergent to water in such an amount so that the concentration of laundry detergent composition in the wash liquor is from 0.2 g/1 to 20 g/1, or from 0.5 g/1 to 10 g/1, or to 5.0 g/1. The method of laundering fabric can be carried out in a front-loading automatic washing machine, top loading automatic washing machines, including high efficiency automatic washing machines, or suitable hand-wash vessels. Typically, the wash liquor comprises 90 litres or less, or 60 litres or less, or 15 litres or less, or 10 litres or less of water. Typically, 200 g or less, or 150 g or less, or 100 g or less, or 50 g or less of laundry detergent composition is contacted to water to form the wash liquor.

### EXAMPLES

Solid Free-Flowing Particulate Laundry Detergent Composition Illustrative Examples:

| Ingredient | Amount (in wt %) |
|---|---|
| Anionic detersive surfactant (such as alkyl benzene | from 8 wt % to 15 wt % |
| sulphonate, alkyl ethoxylated sulphate and mixtures thereof) | |
| Non-ionic detersive surfactant (such as alkyl ethoxylated | from 0.1 wt % to 4 wt % |
| alcohol) | |
| Cationic detersive surfactant (such as quaternary ammonium | from 0 wt % to 4 wt % |
| compounds) | |
| Other detersive surfactant (such as zwiterionic detersive | from 0 wt % to 4 wt % |
| surfactants, amphoteric surfactants and mixtures thereof) | |
| Carboxylate polymer (such as co-polymers of maleic acid and | from 0.1 wt % to 4 wt % |
| acrylic acid and/or carboxylate polymers comprising ether | |
| moieties and sulfonate moieties) | |
| Polyethylene glycol polymer (such as a polyethylene glycol | from 0 wt % to 4 wt % |
| polymer comprising polyvinyl acetate side chains) | |
| Polyester soil release polymer (such as Repel-o-tex and/or | from 0 wt % to 2 wt % |
| Texcare polymers) | |
| Cellulosic polymer (such as carboxymethyl cellulose, methyl | from 0.5 wt % to 2 wt % |
| cellulose and combinations thereof) | |
| Other polymer (such as care polymers) | from 0 wt % to 4 wt % |
| Zeolite builder and phosphate builder (such as zeolite 4A | from 0 wt % to 4 wt % |
| and/or sodium tripolyphosphate) | |
| Other co-builder (such as sodium citrate and/or citric acid) | from 0 wt % to 3 wt % |
| Citric Acid | from 4 wt % to 16 wt % |
| Magnesium Sulphate | from 1 wt % to 4 wt % |
| Carbonate salt (such as sodium carbonate and/or sodium | from 0 wt % to 4 wt % |
| bicarbonate) | |
| Silicate salt (such as sodium silicate) | from 0 wt % to 4 wt % |
| Filler (such as sodium sulphate and/or bio-fillers) | from 10 wt % to 70 wt % |
| Source of hydrogen peroxide (such as sodium percarbonate) | from 0 wt % to 20 wt % |
| Bleach activator (such as tetraacetylethylene diamine (TAED) | from 0 wt % to 8 wt % |
| and/or nonanoyloxybenzenesulphonate (NOBS)) | |
| Bleach catalyst (such as oxaziridinium-based bleach catalyst | from 0 wt % to 0.1 wt % |
| and/or transition metal bleach catalyst) | |
| Other bleach (such as reducing bleach and/or pre-formed | from 0 wt % to 10 wt % |
| peracid) | |
| Photobleach (such as zinc and/or aluminium sulphonated | from 0 wt % to 0.1 wt % |
| phthalocyanine) | |
| Chelant (such as ethylenediamine-N′N′-disuccinic acid | from 0.2 wt % to 1 wt % |
| (EDDS) and/or hydroxyethane diphosphonic acid (HEDP)) | |
| Hueing agent (such as direct violet 9, 66, 99, acid red 50, | from 0 wt % to 1 wt % |
| solvent violet 13 and any combination thereof) | |
| Brightener (C.I. fluorescent brightener 260 or C.I. fluorescent | from 0.1 wt % to 0.4 wt % |
| brightener 351) | |
| Protease (such as Savinase, Savinase Ultra, Purafect, FN3, | from 0.1 wt % to 0.4 wt % |
| FN4 and any combination thereof) | |
| Amylase (such as Termamyl, Termamyl ultra, Natalase, | from 0 wt % to 0.2 wt % |
| Optisize, Stainzyme, Stainzyme Plus and any combination | |
| thereof) | |
| Cellulase (such as Carezyme and/or Celluclean) | from 0 wt % to 0.2 wt % |
| Lipase (such as Lipex, Lipolex, Lipoclean and any | from 0 wt % to 1 wt % |
| combination thereof) | |
| Other enzyme (such as xyloglucanase, cutinase, pectate lyase, | from 0 wt % to 2 wt % |
| mannanase, bleaching enzyme) | |
| Fabric softener (such as montmorillonite clay and/or | from 0 wt % to 15 wt % |
| polydimethylsiloxane (PDMS)) | |
| Flocculant (such as polyethylene oxide) | from 0 wt % to 1 wt % |
| Suds suppressor (such as silicone and/or fatty acid) | from 0 wt % to 4 wt % |
| Perfume (such as perfume microcapsule, spray-on perfume, | from 0.1 wt % to 1 wt % |
| starch encapsulated perfume accords, perfume loaded zeolite, | |
| and any combination thereof) | |
| Aesthetics (such as coloured soap rings and/or coloured | from 0 wt % to 1 wt % |
| speckles/noodles) | |
| Miscellaneous | balance to 100 wt % |

### Example 1—Low pH Formulation with Amylase 1 (Embodiment of the Present Invention)

A low pH base powder was prepared by mixing the ingredients together. The composition of the base powder was:

| | Amount (wt % of |
|---|---|
| Ingredient | base powder) |
| Alkyl benzene sulphonate anionic detersive surfactant | 18.22 |
| Sodium sulphate | 75.23 |
| Citric acid | 6.54 |
| Water & miscellaneous | to 100 wt % |

143 g Sodium sulphate, 18 g sodium carbonate, 18 g sodium silicate and 2.94 g of enzyme prill containing 0.87 g active Amylase 1 (in accordance with claim 1) were added to the 321 g base powder to form 502.94 g of solid free-flowing particulate laundry detergent composition (in accordance with the present invention) having the following formulation:

| | Amount (wt % of |
|---|---|
| Ingredient | composition) |
| Alkyl benzene sulphonate anionic detersive surfactant | 11.7 |
| Sodium sulphate | 76.32 |
| Citric acid | 4.2 |
| Sodium carbonate | 3.6 |
| Sodium silicate | 3.6 |
| Amylase 1 | 0.58 |
| Water & miscellaneous | to 100 wt % |

The composition had an equilibrium pH at 1 wt % dilution in deionized water at 20° C. of 7.0. The compositon had a reserve alkalinity to pH 7 at 1 wt % dilution in deionized water at 20° C. of 2.0.

### Example 2—High pH Formulation with Amylase 1 (Comparative Example)

A high pH base powder was prepared by mixing the ingredients together. The composition of the base powder was:

| | Amount (wt % of |
|---|---|
| Ingredient | base powder) |
| Alkyl benzene sulphonate anionic detersive surfactant | 18.22 |
| Sodium sulphate | 76.23 |
| Citric acid | 6.54 |
| Water & miscellaneous | to 100 wt % |

25 g Sodium sulphate, 100 g sodium carbonate, 50 g sodium silicate, 4 g citric acid and 2.94 g of enzyme prill containing 0.87 g active Amylase 1 were added to the 321 g base powder to form 502.94 g of solid free-flowing particulate laundry detergent composition (comparative example) having the following formulation:

| | Amount (wt % of |
|---|---|
| Ingredient | composition) |
| Alkyl benzene sulphonate anionic detersive surfactant | 11.7 |
| Sodium sulphate | 52.75 |
| Citric acid | 5 |
| Sodium carbonate | 20 |
| Sodium silicate | 10 |
| Amylase 1 | 0.58 |
| Water & miscellaneous | to 100 wt % |

The composition had an equilibrium pH at 1 wt % dilution in deionized water at 20° C. of 10.5. The compositon had a reserve alkalinity to pH 7 at 1 wt % dilution in deionized water at 20° C. of 9.6.

### Example 3—Low pH Formulation without Amylase (Comparative Example)

A low pH base powder was prepared by mixing the ingredients together. The composition of the base powder was:

| | Amount (wt % of |
|---|---|
| Ingredient | base powder) |
| Alkyl benzene sulphonate anionic detersive surfactant | 18.22 |
| Sodium sulphate | 75.23 |
| Citric acid | 6.54 |
| Water & miscellaneous | to 100 wt % |

143 g Sodium sulphate, 18 g sodium carbonate, and 18 g sodium silicate were added to the 321 g base powder to form 500 g of solid free-flowing particulate laundry detergent composition (comparative example) having the following formulation:

| | Amount (wt % of |
|---|---|
| Ingredient | composition) |
| Alkyl benzene sulphonate anionic detersive surfactant | 11.7 |
| Sodium sulphate | 76.9 |
| Citric acid | 4.2 |
| Sodium carbonate | 3.6 |
| Sodium silicate | 3.6 |
| Water & miscellaneous | to 100 wt % |

The composition had an equilibrium pH at 1 wt % dilution in deionized water at 20° C. of 7.0. The compositon had a reserve alkalinity to pH 7 at 1 wt % dilution in deionized water at 20° C. of 2.0.

### Example 4—High pH Formulation without Amylase (Comparative Example)

A high pH base powder was prepared by mixing the ingredients together. The composition of the base powder was:

| | Amount (wt % of |
|---|---|
| Ingredient | base powder) |
| Alkyl benzene sulphonate anionic detersive surfactant | 18.22 |
| Sodium sulphate | 75.23 |
| Citric acid | 6.54 |
| Water & miscellaneous | to 100 wt % |

25 g Sodium sulphate, 100 g sodium carbonate, and 50 g sodium silicate and 4 g citric acid were added to the 321 g base powder to form 500 g of solid free-flowing particulate laundry detergent composition (comparative example) having the following formulation:

| | Amount (wt % of |
|---|---|
| Ingredient | composition) |
| Alkyl benzene sulphonate anionic detersive surfactant | 11.7 |
| Sodium sulphate | 53.3 |
| Citric acid | 5 |
| Sodium carbonate | 20 |
| Sodium silicate | 10 |
| Water & miscellaneous | to 100 wt % |

The composition had an equilibrium pH at 1 wt % dilution in deionized water at 20° C. of 10.5. The compositon had a reserve alkalinity to pH 7 at 1 wt % dilution in deionized water at 20° C. of 9.6.

Washing Method:

The following method demonstrates the ability of Samples 1-8 to remove stains during the wash process. The above samples were added separately into the pots of a tergotometer (quantity of sample=1% of the bulk preparation as described in the Examples, sampled-down uniformly to give a representative sample). The volume of each pot was 1 L. The wash temperature was set to 30° C. Throughout the procedure, 21 gpg water was used. The products were agitated for 2 minutes before addition of fabrics (2 internal replicates of each stain (CFT rice starch on polycotton), and 15 g of WfK SBL 2004 soil sheets per pot with additional knitted cotton ballast to make the total fabric weight up to 35 g). Once the fabrics were added, the wash solution was agitated for 30 minutes. The wash solutions were then drained and the fabrics were subject to a 5 minute rinse step before being drained and spun dry. The washed fabrics were then dried in an airflow cabinet before being analysed to measure the stain removal from the fabric. This procedure was repeated a further two times to give a total of three external replicates.

Stain Removal Analysis:

The fabrics were analysed using commercially available DigiEye software for L, a, b values. SRI values were then calculated from the L, a, b values using the formula shown. The higher the SRI, the better the stain removal. The data demonstrates that the impact of the amylase is greater at pH 7.2 vs. pH 10.5.

% SRI(stain removal)=100*((ΔE_{b}−ΔEₐ)/ΔE_{b})

ΔE_{b}=√((L_{c}−L_{b})²+(a_{c}−a_{b})²+(b_{c}−b_{b})²)

ΔEₐ=√((L_{c}−Lₐ)²+(a_{c}−aₐ)²+(b_{c}−bₐ)²)
Subscript ‘b’ denotes data for the stain before washing
Subscript ‘a’ denotes data for the stain after washing
Subscript ‘c’ denotes data for the unstained fabric

Thus, L*a*b* values are taken of the unstained fabric, of the stained fabric before washing and of the stained fabric after washing.

| Sample | % SRI |
|---|---|
| Sample 1: low pH with Amylase 1 (in accordance | 67.21 |
| with the present invention) | |
| Sample 2: high pH with Amylase 1 (comparative | 32.70 |
| example) | |
| Sample 3: low pH nil amylase (comparative | 27.60 |
| example) | |
| Sample 4: high pH nil amylase (comparative | 26.01 |
| example) | |

### Example 5—pH 8.4 Formulation with 4% Sodium Carbonate with Amylase 1 (Embodiment of the Present Invention)

A low pH base powder was prepared by mixing the ingredients together. The composition of the base powder was:

| | Amount (wt % of |
|---|---|
| Ingredient | base powder) |
| Alkyl benzene sulphonate anionic detersive surfactant | 18.48 |
| Sodium sulphate | 76.30 |
| Citric acid | 5.21 |
| Water & miscellaneous | to 100 wt % |

137 g Sodium sulphate, 20 g sodium carbonate, 18 g sodium silicate, 5 g zeolite builder, 3.5 g citric acid and 2.94 g of enzyme prill containing 0.87 g active Amylase 1 (in accordance with claim 1) were added to the 316.5 g base powder to form 502.94 g of solid free-flowing particulate laundry detergent composition (in accordance with the present invention) having the following formulation:

| | Amount (wt % of |
|---|---|
| Ingredient | composition) |
| Alkyl benzene sulphonate anionic detersive surfactant | 11.7 |
| Sodium sulphate | 75.12 |
| Citric acid | 4 |
| Sodium carbonate | 4 |
| Sodium silicate | 3.6 |
| Zeolite Builder | 1 |
| Amylase 1 | 0.58 |
| Water & miscellaneous | to 100 wt % |

The composition had an equilibrium pH at 1 wt % dilution in deionized water at 20° C. of 8.5.

### Example 6—pH 8.4 Formulation with 10% Sodium Carbonate with Amylase 1 (Comparative Example)

A low pH base powder was prepared by mixing the ingredients together. The composition of the base powder was:

| | Amount (wt % of |
|---|---|
| Ingredient | base powder) |
| Alkyl benzene sulphonate anionic detersive surfactant | 18.48 |
| Sodium sulphate | 76.30 |
| Citric acid | 5.21 |
| Water & miscellaneous | to 100 wt % |

88.5 g Sodium sulphate, 50 g sodium carbonate, 18 g sodium silicate, 5 g zeolite builder, 22 g citric acid and 2.94 g of enzyme prill containing 0.87 g active Amylase 1 (in accordance with claim 1) were added to the 316.5 g base powder to form 502.94 g of solid free-flowing particulate laundry detergent composition (comparative example) having the following formulation:

| | Amount (wt % of |
|---|---|
| Ingredient | composition) |
| Alkyl benzene sulphonate anionic detersive surfactant | 11.7 |
| Sodium sulphate | 65.42 |
| Citric acid | 7.7 |
| Sodium carbonate | 10 |
| Sodium silicate | 3.6 |
| Zeolite Builder | 1 |
| Amylase 1 | 0.58 |
| Water & miscellaneous | to 100 wt % |

The composition had an equilibrium pH at 1 wt % dilution in deionized water at 20° C. of 8.5.

### Example 7—pH 9.7 Formulation with Amylase 1 (Comparative Example)

A high pH base powder was prepared by mixing the ingredients together. The composition of the base powder was:

| | Amount (wt % of |
|---|---|
| Ingredient | base powder) |
| Alkyl benzene sulphonate anionic detersive surfactant | 18.48 |
| Sodium sulphate | 76.30 |
| Citric acid | 5.21 |
| Water & miscellaneous | to 100 wt % |

140.5 g Sodium sulphate, 20 g sodium carbonate, 18 g sodium silicate, 5 g zeolite builder and 2.94 g of enzyme prill containing 0.87 g active Amylase 1 were added to the 316.5 g base powder to form 502.94 g of solid free-flowing particulate laundry detergent composition (comparative example) having the following formulation:

| | Amount (wt % of |
|---|---|
| Ingredient | composition) |
| Alkyl benzene sulphonate anionic detersive surfactant | 11.7 |
| Sodium sulphate | 75.82 |
| Citric acid | 3.3 |
| Sodium carbonate | 4 |
| Sodium silicate | 3.6 |
| Zeolite Builder | 1 |
| Amylase 1 | 0.58 |
| Water & miscellaneous | to 100 wt % |

The composition had an equilibrium pH at 1 wt % dilution in deionized water at 20° C. of 9.7

### Example 8—pH 8.4 Formulation with 4% Sodium Carbonate without Amylase 1 (Comparititve Example)

A low pH base powder was prepared by mixing the ingredients together. The composition of the base powder was:

| | Amount (wt % of |
|---|---|
| Ingredient | base powder) |
| Alkyl benzene sulphonate anionic detersive surfactant | 18.48 |
| Sodium sulphate | 76.30 |
| Citric acid | 5.21 |
| Water & miscellaneous | to 100 wt % |

137 g Sodium sulphate, 20 g sodium carbonate, 18 g sodium silicate, 5 g zeolite builder and 3.5 g citric acid were added to the 316.5 g base powder to form 500 g of solid free-flowing particulate laundry detergent composition (comparative example) having the following formulation:

| | Amount (wt % of |
|---|---|
| Ingredient | composition) |
| Alkyl benzene sulphonate anionic detersive surfactant | 11.7 |
| Sodium sulphate | 75.7 |
| Citric acid | 4 |
| Sodium carbonate | 4 |
| Sodium silicate | 3.6 |
| Zeolite Builder | 1 |
| Water & miscellaneous | to 100 wt % |

The composition had an equilibrium pH at 1 wt % dilution in deionized water at 20° C. of 8.5.

### Example 9—pH 8.4 Formulation with 10% Sodium Carbonate without Amylase 1 (Comparative Example)

A low pH base powder was prepared by mixing the ingredients together. The composition of the base powder was:

| | Amount (wt % of |
|---|---|
| Ingredient | base powder) |
| Alkyl benzene sulphonate anionic detersive surfactant | 18.48 |
| Sodium sulphate | 76.30 |
| Citric acid | 5.21 |
| Water & miscellaneous | to 100 wt % |

88.5 g Sodium sulphate, 50 g sodium carbonate, 18 g sodium silicate, 5 g zeolite builder and 22 g citric acid were added to the 316.5 g base powder to form 500 g of solid free-flowing particulate laundry detergent composition (comparative example) having the following formulation:

| | Amount (wt % of |
|---|---|
| Ingredient | composition) |
| Alkyl benzene sulphonate anionic detersive surfactant | 11.7 |
| Sodium sulphate | 66 |
| Citric acid | 7.7 |
| Sodium carbonate | 10 |
| Sodium silicate | 3.6 |
| Zeolite Builder | 1 |
| Water & miscellaneous | to 100 wt % |

The composition had an equilibrium pH at 1 wt % dilution in deionized water at 20° C. of 8.5.

### Example 10—pH 9.7 Formulation without Amylase 1 (Comparative Example)

A high pH base powder was prepared by mixing the ingredients together. The composition of the base powder was:

| | Amount (wt % of |
|---|---|
| Ingredient | base powder) |
| Alkyl benzene sulphonate anionic detersive surfactant | 18.48 |
| Sodium sulphate | 76.30 |
| Citric acid | 5.21 |
| Water & miscellaneous | to 100 wt % |

140.5 g Sodium sulphate, 20 g sodium carbonate, 18 g sodium silicate, 5 g zeolite builder were added to the 316.5 g base powder to form 500 g of solid free-flowing particulate laundry detergent composition (comparative example) having the following formulation:

| | Amount (wt % of |
|---|---|
| Ingredient | composition) |
| Alkyl benzene sulphonate anionic detersive surfactant | 11.7 |
| Sodium sulphate | 76.4 |
| Citric acid | 3.3 |
| Sodium carbonate | 4 |
| Sodium silicate | 3.6 |
| Zeolite Builder | 1 |
| Water & miscellaneous | to 100 wt % |

The composition had an equilibrium pH at 1 wt % dilution in deionized water at 20° C. of 9.7

Washing Method:

The following method demonstrates the ability of Samples 1-6 to remove stains during the wash process. The above samples were added separately into the pots of a tergotometer (quantity of sample=1% of the bulk preparation as described in the Examples, sampled-down uniformly to give a representative sample). The volume of each pot was 1 L. The wash temperature was set to 20° C. Throughout the procedure, 0.05 gpg water was used. The products were agitated for 2 minutes before addition of fabrics (2 internal replicates of each stain (CFT rice starch on polycotton), and 15 g of WfK SBL 2004 soil sheets per pot with additional knitted cotton ballast to make the total fabric weight up to 35 g). Once the fabrics were added, the wash solution was agitated for 20 minutes. The wash solutions were then drained and the fabrics were subject to a 5 minute rinse step before being drained and spun dry. The washed fabrics were then dried in an airflow cabinet before being analysed to measure the stain removal from the fabric. This procedure was repeated a further three times to give a total of four external replicates.

Stain Removal Analysis:

The fabrics were analysed using commercially available DigiEye software for L, a, b values. SRI values were then calculated from the L, a, b values using the formula shown. The higher the SRI, the better the stain removal. The data demonstrates that the impact of the amylase is greater at pH 7.2 vs. pH 10.5.

% SRI(stain removal)=100*((ΔE_{b}−ΔEₐ)/ΔE_{b})

ΔE_{b}=√((L_{c}−L_{b})²+(a_{c}−a_{b})²+(b_{c}−b_{b})²)

ΔEₐ=√((L_{c}−Lₐ)²+(a_{c}−aₐ)²+(b_{c}−bₐ)²)
Subscript ‘b’ denotes data for the stain before washing
Subscript ‘a’ denotes data for the stain after washing
Subscript ‘c’ denotes data for the unstained fabric

Thus, L*a*b* values are taken of the unstained fabric, of the stained fabric before washing and of the stained fabric after washing.

| | Delta SRI Vs Nil |
|---|---|
| Sample | Amylase |
| Example 5: pH 8.5 with 4% Carbonate with | 42.51 |
| Amylase 1 (in accordance with the present | |
| invention) | |
| Example 6: pH 8.5 with 10% Carbonate with | 40.15 |
| Amylase 1 (comparative example) | |
| Example 7: pH 9.7 with amylase 1 (comparative | 38.70 |
| example) | |

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A solid free flowing particulate laundry detergent composition comprising:
(a) anionic detersive surfactant;
(b) wherein the composition is essentially free of zeolite builder;
(c) wherein the composition is essentially free of phosphate builder;
(d) wherein the composition is essentially free of sodium carbonate;
(e) wherein the composition is essentially free of sodium silicate;
(f) from about 4 wt % to about 20 wt % organic acid; and
(g) a variant of the wild-type amylase from Bacillus sp. which has at least 90% identity for amino acid sequence SEQ ID NO:5, and which comprises one or more mutations at positions N195, G477, G304, W140, W189, D134, V206, Y243, E260, F262, W284, W347, W439, W469 and/or G476,
wherein the composition at 1 wt % dilution in deionized water at 20° C., has an equilibrium pH in the range of from about 6.5 to about 9.0.

2. A composition according to claim 1, wherein the amylase comprises the deletions of D183* and/or G184*.

3. A composition according to claim 1, wherein the composition comprises from about 30 wt % to about 90 wt % base detergent particle, wherein the base detergent particle comprising (by weight of the base detergent particle):
(a) from about 4 wt % to about 35 wt % anionic detersive surfactant;
(b) from about 1 wt % to about 8 wt % zeolite builder;
(c) wherein the particle is essentially free of phosphate builder;
(d) wherein the particle is essentially free of sodium carbonate;
(e) wherein the particle is essentially free of sodium silicate;
(f) from about 1 wt % to about 10 wt % organic acid,

4. A composition according to claim 1, wherein:
(a) the anionic detersive surfactant comprises alkyl benzene sulphonate and wherein the base detergent particle comprises from about 4 wt % to about 35 wt % alkyl benzene sulphonate; and/or
(b) the base detergent particle comprises from about 0.5 wt % to about 5 wt % carboxylate co-polymer, wherein the carboxylate co-polymer comprises:
(i) from about 50 to less than about 98 wt % structural units derived from one or more monomers comprising carboxyl groups;
(ii) from about 1 to less than about 49 wt % structural units derived from one or more monomers comprising sulfonate moieties; and
(iii) from about 1 to about 49 wt % structural units derived from one or more types of monomers selected from ether bond-containing monomers represented by formulas (I) and (II): 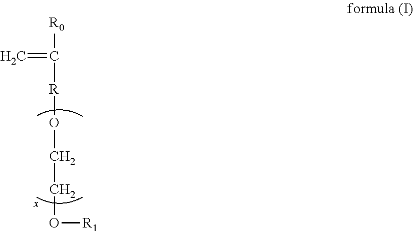
wherein in formula (I), R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group; 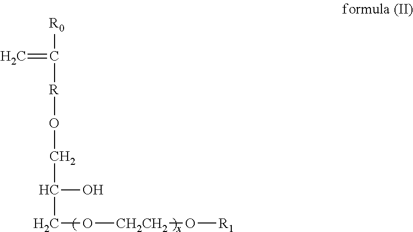
wherein in formula (II), R₀ represents a hydrogen atom or CH₃ group, R represents a CH₂ group, CH₂CH₂ group or single bond, X represents a number 0-5, and R₁ is a hydrogen atom or C₁ to C₂₀ organic group; and/or
(c) wherein the base detergent particle comprises from about 30 wt % to about 70 wt % sodium sulphate.

5. A composition according to claim 1, wherein the composition comprises from about 1 wt % to about 20 wt % co-surfactant particle, wherein the co-surfactant particle comprises:
(a) from about 25 wt % to about 60 wt % co-surfactant;
(b) from about 10 wt % to about 50 wt % carbonate salt; and
(c) from about 1 wt % to about 30 wt % silica.

6. A composition according to claim 1 wherein the composition at 1 wt % dilution in deionized water at 20° C., has an equilibrium pH in the range of from about 6.5 to about 8.0.

7. A composition according to claim 1, wherein the composition comprises:
(a) wherein the composition is essentially free of sodium bicarbonate;
(b) wherein the composition is essentially free of sodium carbonate;
(c) wherein the composition is essentially free of sodium silicate; and
(d) wherein the composition is essentially free of phosphate builder.

8. A composition according to claim 1, wherein the composition comprises the combination of a lipase enzyme and soil release polymer.

9. A composition according to claim 1 wherein the composition comprises:
(a) alkyl benzene sulphonate, wherein the alkyl benzene sulphonate comprises at least about 25 wt % of the combined total of 2-phenyl isomer and 3-phenyl isomer; and/or
(b) alkyl amine oxide.

10. A composition according to claim 1, wherein the composition comprises:
(a) from about 0.5 wt % to about 8 wt % carboxylate co-polymer, wherein the carboxylate co-polymer comprises:
(i) from about 50 to less than about 98 wt % structural units derived from one or more monomers comprising carboxyl groups;
(ii) from about 1 to less than about 49 wt % structural units derived from one or more monomers comprising sulfonate moieties; and
(iii) from about 1 to about 49 wt % structural units derived from one or more types of monomers selected from ether bond-containing monomers represented by formulas (I) and (II): 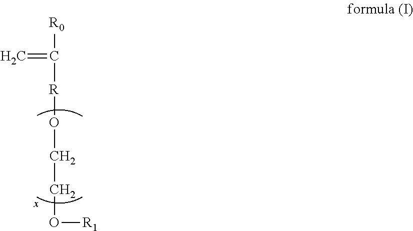
wherein in formula (I), R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group; 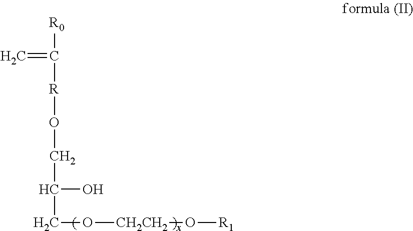
wherein in formula (II), R₀ represents a hydrogen atom or CH₃ group, R represents a CH₂ group, CH₂CH₂ group or single bond, X represents a number 0-5, and R₁ is a hydrogen atom or C₁ to C₂₀ organic group; and/or
(b) polyethylene glycol polymer, wherein the polyethylene glycol polymer comprises a polyethylene glycol backbone with grafted polyvinyl acetate side chains; and/or
(c) polyester soil release polymer having the structure: 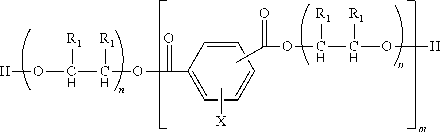
wherein n is from 1 to 10; m is from 1 to 15;
X is H or SO₃Me;
wherein Me is H, Na⁺, Li⁺, K⁺, Mg²⁺, Ca²⁺, Al³⁺, ammonium, mono-, di-, tri-, or tetra-alkylammonium; wherein the alkyl groups are C₁-C₁₈ alkyl or C₂-C₁₀ hydroxyalkyl, or any mixture thereof;
R1 are independently selected from H or C₁-C₁₈ n- or iso-alkyl; and/or
(d) polyester soil release polymer consisting of structure units (1) to (3): 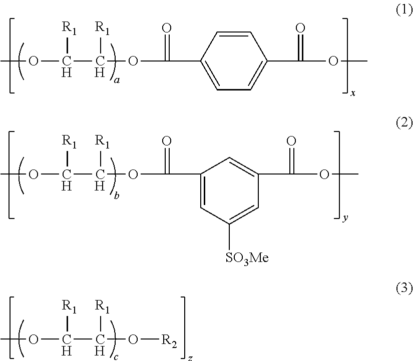
wherein:
a, b and c are from 1 to 10;
x, y is from 1 to 10;
z is from 0.1 to 10;
Me is H, Na⁺, Li⁺, K⁺, Mg²⁺, Ca²⁺, Al³⁺, ammonium, mono-, di-, tri-, or tetra-alkylammonium wherein the alkyl groups are C₁-C₁₈ alkyl or C₂-C₁₀ hydroxyalkyl, or any mixture thereof;
R₁, are independently selected from H or C₁-C₁₈ n- or iso-alkyl;
R2 is a linear or branched C₁-C₁₈ alkyl, or a linear or branched C₂-C₃₀ alkenyl, or a cycloalkyl group with 5 to 9 carbon atoms, or a C₆-C₃₀ aryl group, or a C₆-C₃₀ arylalkyl group; and/or
(e) carboxymethyl cellulose having a degree of substitution greater than about 0.65 and a degree of blockiness greater than about 0.45; and/or
(f) alkoxylated polyalkyleneimine, wherein said alkoxylated polyalkyleneimine has a polyalkyleneimine core with one or more side chains bonded to at least one nitrogen atom in the polyalkyleneimine core, wherein said alkoxylated polyalkyleneimine has an empirical formula (I) of (PEI)ₐ-(EO)_{b}-R₁, wherein a is the average number-average molecular weight (MW_{PEI}) of the polyalkyleneimine core of the alkoxylated polyalkyleneimine and is in the range of from about 100 to about 100,000 Daltons, wherein b is the average degree of ethoxylation in said one or more side chains of the alkoxylated polyalkyleneimine and is in the range of from about 5 to about 40, and wherein R₁ is independently selected from the group consisting of hydrogen, C₁-C₄ alkyls, and combinations thereof; and/or
(g) alkoxylated polyalkyleneimine, wherein said alkoxylated polyalkyleneimine has a polyalkyleneimine core with one or more side chains bonded to at least one nitrogen atom in the polyalkyleneimine core, wherein the alkoxylated polyalkyleneimine has an empirical formula (II) of (PEI)ₒ-(EO)ₘ(PO)ₙ-R₂ or (PEI)ₒ-(PO)ₙ(EO)ₘ-R₂, wherein o is the average number-average molecular weight (MW_{PEI}) of the polyalkyleneimine core of the alkoxylated polyalkyleneimine and is in the range of from about 100 to about 100,000 Daltons, wherein m is the average degree of ethoxylation in said one or more side chains of the alkoxylated polyalkyleneimine which ranges from about 10 to about 50, wherein n is the average degree of propoxylation in said one or more side chains of the alkoxylated polyalkyleneimine which ranges from about 1 to about 50, and wherein R2 is independently selected from the group consisting of hydrogen, C₁-C₄ alkyls, and combinations thereof; and/or
(h) the combination of a non-ionic soil release polymer and an anionic soil release polymer.

11. A composition according to claim 1, wherein the composition is substantially free of pre-formed peracid.

12. A composition according to claim 1, wherein the composition comprises:
(a) from about 1 wt % to about 20 wt % sodium percarbonate;
(b) from about 0.5 wt % to about 5 wt % bleach activator; and
(c) from about 0.5 wt % to about 5 wt % chelant.

13. A composition according to claim 1, wherein the composition comprises from about 0.5 wt % to about 5 wt % sodium tetraacetylethylenediamine.

14. A composition according to claim 1, wherein the composition comprises:
(a) from about 0.5 wt % to about 5 wt % tri sodium salt of methylglycine diacetic acid (MGDA); and/or
(b) from about 0.5 wt % to about 5 wt % ethylenediamine disuccinic acid (EDDS).

15. A composition according to claim 1, wherein the composition comprises 4,4′-bis-(triazinylamino)-stilbene-2,2′-disulfonic acid brightener and/or 4,4′-distyryl biphenyl brightener.

16. A composition according to claim 1, wherein the composition comprises from about 0.5 wt % to about 4 wt % disodium 4,5-dihydroxy-1,3-benzenedisulfonate.

17. A composition according to claim 1, wherein the composition comprises acyl hydrazone bleach catalyst, wherein the acyl hydrazone bleach catalyst has the formula I: 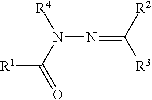
wherein, R₁ is selected from the groups comprising CF₃, C₁₋₂₈ alkyl, C₂₋₂₈ alkenyl, C₂₋₂₂ alkynyl, C₃₋₁₂ cycloalkyl, C₃₋₁₂ cycloalkenyl, phenyl, naphthyl, C₇₋₉ aralkyl, C₃₋₂₀ heteroalkyl, C₃₋₁₂ cycloheteroalkyl or a mixture thereof;
R² and R³ are independently selected from the group comprising hydrogen, substituted C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₈ heteroalkyl, C₃₋₁₂ cycloheteroalkyl, C₅₋₁₆ heteroaralkyl, phenyl, naphthyl, heteroaryl or a mixture thereof;
or R² and R³ are linked to form a substituted 5-, 6-, 7-, 8- or 9-membered ring;
and R⁴ is selected from the groups comprising hydrogen, C₁₋₂₈ alkyl, C₂₋₂₈ alkenyl, C₂₋₂₂ alkynyl, C₃₋₁₂ cycloalkyl, C₃₋₁₂ cycloalkenyl, C₇₋₉ aralkyl, C₃₋₂₀ heteroalkyl, C₃₋₁₂ cycloheteroalkyl, C₅₋₁₆ heteroaralkyl, substituted phenyl, naphthyl, heteroaryl or a mixture thereof.

18. A composition according to claim 1, wherein the composition comprises:
(a) hueing agent having the following structure: 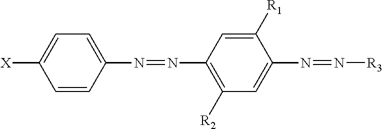
wherein:
R1 and R2 are independently selected from the group consisting of: H; alkyl; alkoxy;
alkyleneoxy; alkyl capped alkyleneoxy; urea; and amido;
R3 is a substituted aryl group;
X is a substituted group comprising sulfonamide moiety, and wherein the substituent group comprises at least one alkyleneoxy chain that comprises an average molar distribution of at least four alkyleneoxy moieties; and/or
(b) hueing agent having the following structure: 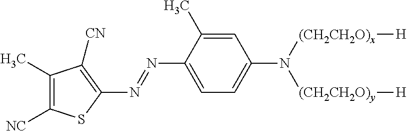
wherein the index values x and y are independently selected from 1 to 10; and/or
(c) hueing agent selected from Acid Violet 50, Direct Violet 9, 66 and 99, Solvent Violet 13 and any combination thereof.

19. A composition according to claim 1, wherein the composition comprises an enzyme selected from:
(a) protease having at least 90% identity to the amino acid sequence of Bacillus amyloliquefaciens as shown in SEQ ID NO:9;
(b) protease having at least 90% identity to the amino acid sequence of Bacillus amyloliquefaciens BPN′ as shown in SEQ ID NO:10, and which comprises one or more mutations selected from group consisting of V4I, S9R, A15T, S24G, S33T, S53G, V68A, N76D, S78N, S101M/N, Y167F, and Y217Q;
(c) protease having at least 90% identity to the amino acid sequence of Bacillus the rmoproteolyticus as shown in SEQ ID NO:11;
(d) protease having at least 90% identity to the amino acid sequence of Bacillus lentus as shown in SEQ IS NO:12, and which comprises one or mutations selected from the group consisting of S3T, V4I, A194P, V199M, V205I, and L217D;
(e) protease having at least 90% identity to the amino acid sequence of Bacillus sp. TY145 as shown in SEQ ID NO:13;
(f) protease having at least 90% identity to the amino acid sequence of Bacillus sp. KSM-KP43 as shown in SEQ ID NO:14;
(g) variant of the wild-type amylase from Bacillus sp. which has at least 90% identity for amino acid sequence SEQ ID NO:6, and which comprises one or more mutations at positions 9, 26, 30, 33, 82, 37, 106, 118, 128, 133, 149, 150, 160, 178, 182, 186, 193, 195, 202, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482 and/or 484;
(h) variant of the wild-type amylase from Bacillus sp. KSM-K38 which has at least 90% identity for amino acid sequence SEQ ID NO:7;
(i) variant of the wild-type amylase from Cytophaga sp. which has at least 60% identity for amino acid sequence SEQ ID NO:8;
(j) a variant of the wild-type lipase from Thermomyces lanuginosus which has at least 90% identity for amino acid sequence SEQ ID NO:1;
(k) variant of the wild-type lipase from Thermomyces lanuginosus which has at least 90% identity for amino acid sequence SEQ ID NO:1, and which comprises T231R and/or N233R mutations;
(l) variant of the wild-type lipase from Thermomyces lanuginosus which has at least 90% identity for amino acid sequence SEQ ID NO:1, and which comprises G91A, D96G, G225R, T231R and/or N233R mutations;
(m) cellulase that is a wild-type or variant of a microbially-derived endoglucanase endogenous to Bacillus sp. exhibiting endo-beta-1,4-glucanase activity (E.C. 3.2.1.4) which has at least 90% identity to the amino acid sequence SEQ ID NO:2;
(n) cellulase that is a wild-type or variant of a microbially-derived endoglucanase endogenous to Paenibacillus polymyxa exhibiting endo-beta-1,4-glucanase activity (E.C. 3.2.1.4) which has at least 90% identity to amino acid sequence SEQ ID NO:3;
(o) cellulase that is a hybrid fusion endoglucanase comprising a Glycosyl Hydrolase Family 45 catalytic domain that is a wild-type or variant of a microbially-derived endoglucanase endogenous to Melanocarpus albomyces, and a carbohydrate binding module that is a wild-type or variant of a carbohydrate binding module endogenous to Trichoderma reesei, and which has at least 90% identity to amino acid sequence SEQ ID NO:4;
(p) an enzyme selected from mannanase, pectate lyase, laccase, polyesterase, galactanase, acyltransferase, and any combination thereof; and
(q) any combination thereof.

20. A composition according to claim 1, wherein the composition comprises a perfume, wherein the perfume comprises from about 60 wt % to about 85 wt % ester perfume raw materials having the structure: 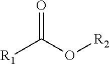
wherein R1 and R2 are independently selected from C₁ to C₃₀ linear or branched, cyclic or non-cyclic, aromatic or non-aromatic, saturated or un-saturated, substituted or unsubstituted alkyl.


SEQUENCE LISTING (14 sequences)

SEQ ID NO: 1 - protein, 269 aa, Thermomyces lanuginosus [sequence omitted]

SEQ ID NO: 2 - protein, 773 aa, Bacillus sp.
AEGNTREDNFKHLLGNDNVKRPSEAGALQLQEVDGQMTLVDQHGEKIQLRGMSTHGLQWFPEILNDNAYKALANDWESNMIRLAMYVGENGYASNPELIKSRVIKGIDLAIENDMYVIVDWHVHAPGDPRDPVYAGAEDFFRDIAALYPNNPHIIYELANEPSSNNNGGAGIPNNEEGWNAVKEYADPIVEMLRDSGNADDNIIIVGSPNWSQRPDLAADNPINDHHTMYTVHFYTGSHAASTESYPPETPNSERGNVMSNTRYALENGVAVFATEWGTSQANGDGGPYFDEADVWIEFLNENNISWANWSLTNKNEVSGAFTPFELGKSNATNLDPGPDHVWAPEELSLSGEYVRARIKGVNYEPIDRTKYTKVLWDFNDGTKQGFGVNSDSPNKELIAVDNENNTLKVSGLDVSNDVSDGNFWANARLSADGWGKSVDILGAEKLTMDVIVDEPTTVAIAAIPQSSKSGWANPERAVRVNAEDFVQQTDGKYKAGLTITGEDAPNLKNIAFHEEDNNMNNIILFVGTDAADVIYLDNIKVIGTEVEIPVVHDPKGEAVLPSVFEDGTRQGWDWAGESGVKTALTIEEANGSNALSWEFGYPEVKPSDNWATAPRLDFWKSDLVRGENDYVAFDFYLDPVRATEGAMNINLVFQPPTNGYWVQAPKTYTINFDELEEANQVNGLYHYEVKINVRDITNIQDDTLLRNMMIIFADVESDFAGRVFVDNVRFEGAATTEPVEPEPVDPGEETPPVDEKEAKKEQKEAEKEEKEE

SEQ ID NO: 3 - protein, 524 aa, Paenibacillus polymyxa
VVHGQTAKTITIKVDTFKDRKPISPYIYGTNQDLAGDENMAARRLGGNRMTGYNWENNMSNAGSDWQQSSDNYLCSNGGLTQAECEKPGAVTTSFHDQSLKLGTYSLVTLPMAGYVAKDGNGSVQESEKAPSARWNQVVNAKNAPFQLQPDLNDNRVYVDEFVHFLVNKYGTASTKAGVKGYALDNEPALWSHTHPRIHGEKVGAKELVDRSVSLSKAVKAIDAGAEVFGPVLYGFGAYKDLQTAPDWDSVKGNYSWFVDYYLDQMRLSSQVEGKRLLDVFDVHWYPEAMGGGIRITNEVGNDETKKARMQAPRTLWDPTYKEDSWIAQWNSEFLPILPRLKQSVDKYYPGTKLAMTEYSYGGENDISGGIAMTDVLGILGKNDVYMANYWKLKDGVNNYVSAAYKLYRNYDGKNSTFGDTSVSAQTSDIVNSSVHASVTNASDKELHLVVMNKSMDSAFDAQFDLSGAKTYISGKVWGFDKNSSQIKEAAPITQISGNRFTYTVPPLTAYHIVLTTGNDTSPV

SEQ ID NO: 4 - protein, 283 aa, Artificial Sequence
  Hybrid protein containing fragments originating from proteins endogenous to Melanocarpus albomyces and Trichoderma reesei
ANGQSTRYWDCCKPSCGWRGKGPVNQPVYSCDANFQRIHDFDAVSGCEGGPAFSCADHSPWAINDNLSYGFAATALSGQTEESWCCACYALTFTSGPVAGKTMVVQSTSTGGDLGSNHFDLNIPGGGVGLFDGCTPQFGGLPGARYGGISSRQECDSFPEPLKPGCQWRFDWFQNADNPSFTFERVQCPEELVARTGCRRHDDGGFPAVQIPSSTGNPSGGNPPGGNPPGTTTTRRPATTTGSSPGPTQSHYGQCGGIGYSGPTVCASGTTCQVLNPYYSQCL

SEQ ID NO: 5 - protein, 485 aa, Bacillus sp.
HHNGTNGTMMQYFEWHLPNDGNHWNRLRDDASNLRNRGITAIWIPPAWKGTSQNDVGYGAYDLYDLGEFNQKGTVRTKYGTRSQLESAIHALKNNGVQVYGDVVMNHKGGADATENVLAVEVNPNNRNQEISGDYTIEAWTKFDFPGRGNTYSDFKWRWYHFDGVDWDQSRQFQNRIYKFRGDGKAWDWEVDSENGNYDYLMYADVDMDHPEVVNELRRWGEWYTNTLNLDGFRIDAVKHIKYSFTRDWLTHVRNATGKEMFAVAEFWKNDLGALENYLNKTNWNHSVFDVPLHYNLYNASNSGGNYDMAKLLNGTVVQKHPMHAVTFVDNHDSQPGESLESFVQEWFKPLAYALILTREQGYPSVFYGDYYGIPTHSVPAMKAKIDPILEARQNFAYGTQHDYFDHHNIIGWTREGNTTHPNSGLATIMSDGPGGEKWMYVGQNKAGQVWHDITGNKPGTVTINADGWANFSVNGGSVSIWVKR

SEQ ID NO: 6 - protein, 485 aa, Bacillus sp.
HHNGTNGTMMQYFEWYLPNDGNHWNRLRSDASNLKDKGISAVWIPPAWKGASQNDVGYGAYDLYDLGEFNQKGTIRTKYGTRNQLQAAVNALKSNGIQVYGDVVMNHKGGADATEMVRAVEVNPNNRNQEVSGEYTIEAWTKFDFPGRGNTHSNFKWRWYHFDGVDWDQSRKLNNRIYKFRGDGKGWDWEVDTENGNYDYLMYADIDMDHPEVVNELRNWGVWYTNTLGLDGFRIDAVKHIKYSFTRDWINHVRSATGKNMFAVAEFWKNDLGAIENYLNKTNWNHSVFDVPLHYNLYNASKSGGNYDMRQIFNGTVVQRHPMHAVTFVDNHDSQPEEALESFVEEWFKPLAYALTLTREQGYPSVFYGDYYGIPTHGVPAMKSKIDPILEARQKYAYGRQNDYLDHHNIIGWTREGNTAHPNSGLATIMSDGAGGNKWMFVGRNKAGQVWTDITGNRAGTVTINADGWGNFSVNGGSVSIWVNK

SEQ ID NO: 7 - protein, 480 aa, Bacillus sp. KSM-K38
DGLNGTMMQYYEWHLENDGQHWNRLHDDAAALSDAGITAIWIPPAYKGNSQADVGYGAYDLYDLGEFNQKGTVRTKYGTKAQLERAIGSLKSNDINVYGDVVMNHKMGADFTEAVQAVQVNPTNRWQDISGAYTIDAWTGFDFSGRNNAYSDFKWRWFHFNGVDWDQRYQENHIFRFANTNWNWRVDEENGNYDYLLGSNIDFSHPEVQDELKDWGSWFTDELDLDGYRLDAIKHIPFWYTSDWVRHQRNEADQDLFVVGEYWKDDVGALEFYLDEMNWEMSLFDVPLNYNFYRASQQGGSYDMRNILRGSLVEAHPMHAVTFVDNHDTQPGESLESWVADWFKPLAYATILTREGGYPNVFYGDYYGIPNDNISAKKDMIDELLDARQNYAYGTQHDYFDHWDVVGWTREGSSSRPNSGLATIMSNGPGGSKWMYVGRQNAGQTWTDLTGNNGASVTINGDGWGEFFTNGGSVSVYVNQ

SEQ ID NO: 8 - protein, 483 aa, Cytophaga sp.
AATNGTMMQYFEWYVPNDGQQWNRLRTDAPYLSSVGITAVWTPPAYKGTSQADVGYGPYDLYDLGEFNQKGTVRTKYGTKGELKSAVNTLHSNGIQVYGDVVMNHKAGADYTENVTAVEVNPSNRNQETSGEYNIQAWTGFNFPGRGTTYSNFKWQWFHFDGTDWDQSRSLSRIFKFTGKAWDWPVSSENGNYDYLMYADYDYDHPDVVNEMKKWGVWYANEVGLDGYRLDAVKHIKFSFLKDWVDNARAATGKEMFTVGEYWQNDLGALNNYLAKVNYNQSLFDAPLHYNFYAASTGGGYYDMRNILNNTLVASNPTKAVTLVENHDTQPGQSLESTVQPWFKPLAYAFILTRSGGYPSVFYGDMYGTKGTTTREIPALKSKIEPLLKARKDYAYGTQRDYIDNPDVIGWTREGDSTKAKSGLATVITDGPGGSKRMYVGTSNAGEIWYDLTGNNSTKITIGSDGYATFPVNKGSVSVWVQQ

SEQ ID NO: 9 - protein, 300 aa, Bacillus amyloliquefaciens
AATTGTGTTLKGKTVSLNISSESGKYVLRDLSKPTGTQIITYDLQNREYNLPGTLVSSTTNQFTTSSQRAAVDAHYNLGKVYDYFYQKFNRNSYDNKGGKIVSSVHYGSRYNNAAWIGDQMIYGDGDGSFFSPLSGSMDVTAHEMTHGVTQETANLNYENQPGALNESFSDVFGYFNDTEDWDIGEDITVSQPALRSLSNPTKYGQPDNFKNYKNLPNTDAGDYGGVHTNSGIPNKAAYNTITKIGVNKAEQIYYRALTVYLTPSSTFKDAKAALIQSARDLYGSQDAASVEAAWNAVGL

SEQ ID NO: 10 - protein, 275 aa, Bacillus amyloliquefaciens [sequence omitted]

SEQ ID NO: 11 - protein, 316 aa, Bacillus thermoproteolyticus
ITGTSTVGVGRGVLGDQKNINTTYSTYYYLQDNTRGNGIFTYDAKYRTTLPGSLWADADNQFFASYDAPAVDAHYYAGVTYDYYKNVHNRLSYDGNNAAIRSSVHYSQGYNNAFWNGSQMVYGDGDGQTFIPLSGGIDVVAHELTHAVTDYTAGLIYQNESGAINEAISDIFGTLVEFYANKNPDWEIGEDVYTPGISGDSLRSMSDPAKYGDPDHYSKRYTGTQDNGGVHINSGIINKAAYLISQGGTHYGVSVVGIGRDKLGKIFYRALTQYLTPTSNFSQLRAAAVQSATDLYGSTSQEVASVKQAFDAVGVK

SEQ ID NO: 12 - protein, 269 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 13 - protein, 311 aa, Bacillus sp. TY145 [sequence omitted]

SEQ ID NO: 14 - protein, 434 aa, Bacillus sp. KSM-KP43
NDVARGIVKADVAQSSYGLYGQGQIVAVADTGLDTGRNDSSMHEAFRGKITALYALGRTNNANDTNGHGTHVAGSVLGNGSTNKGMAPQANLVFQSIMDSGGGLGGLPSNLQTLFSQAYSAGARIHTNSWGAAVNGAYTTDSRNVDDYVRKNDMTILFAAGNEGPNGGTISAPGTAKNAITVGATENLRPSFGSYADNINHVAQFSSRGPTKDGRIKPDVMAPGTFILSARSSLAPDSSFWANHDSKYAYMGGTSMATPIVAGNVAQLREHFVKNRGITPKPSLLKAALIAGAADIGLGYPNGNQGWGRVTLDKSLNVAYVNESSSLSTSQKATYSFTATAGKPLKISLVWSDAPASTTASVTLVNDLDLVITAPNGTQYVGNDFTSPYNDNWDGRNNVENVFINAPQSGTYTIEVQAYNVPVGPQTFSLAIVN